(19) United States
(12) Patent Application Publication
(10) Pub. No.: US 2015/0052054 A1
(43) Pub. Date: Feb. 19, 2015

(54) PURCHASING SERVICE PROVIDING METHOD, PURCHASING SERVICE PROVIDING APPARATUS, AND RECORDING MEDIUM

(71) Applicant: FUJITSU LIMITED, Kawasaki-shi (JP)

(72) Inventor: Naoto Tanba, Yokohama (JP)

(73) Assignee: FUJITSU LIMITED, Kawasaki-shi (JP)

(21) Appl. No.: 14/326,811

(22) Filed: Jul. 9, 2014

(30) Foreign Application Priority Data
Aug. 13, 2013 (JP) 2013-168213

(51) Int. Cl. G06Q 20/40

(52) U.S. Cl. CPC G06Q 20/403
USPC 705/44

(57) ABSTRACT

A purchasing service providing method includes transmitting, to a second computer, a request for payment delegation in which payment of a price of a product or a service to be purchased through a first computer is delegated to the second computer; receiving a payment request for the payment of the price from the first computer, the payment request including information of a name and the price of the product or the service; transmitting the payment request to the second computer, and conducting processing for the payment using funds when an instruction is received from the second computer, when a permission notification is received from the second computer and the price is more than a credit limit; and conducting the processing using the funds and updating the credit limit based on the price, when the permission notification is received and the price is less than or equal to the credit limit.

### CROSS-REFERENCE TO RELATED APPLICATION

This application is based upon and claims the benefit of priority of the prior Japanese Patent Application No. 2013-168213, filed on Aug. 13, 2013, the entire contents of which are incorporated herein by reference.

### FIELD

The embodiments discussed herein are related to a purchasing service providing method, a purchasing service providing apparatus, and a recording medium.

### BACKGROUND

As techniques for realizing an e-commerce transaction in which the purchaser and the payer are different, the following techniques have been disclosed. For example, Japanese Laid-open Patent Publication No. 2001-283126 discloses a first technique which includes steps of mediating an order procedure between the payer and the payee of a transaction, temporarily suspending the order procedure until a payment procedure has been completed, saving information to be used for restarting the order procedure, and restarting the order procedure once the payment procedure has been completed.

Japanese Laid-open Patent Publication No. 2001-283131 discloses a second technique in which when a registered consumer is a member of a family whose head is in contract with a public service provider, the maximum amount that may be paid by the family member to a seller is determined in advance based on public utility bill direct debit account information of the household. In the second technique, when the consumer requests a price settlement agency to make a payment in order for the consumer to purchase a product from the seller through a website, it is determined whether or not the price settlement may be permitted, based on the information of the public utility bill direct debit account.

A third technique is disclosed on the Internet website <URL:http://www.onedarijyouzu.jp/guide.html>, [searched on Jun. 27, 2010], [online], “Onedari Jyouzu”, by Azia Co., Ltd., in which when a “Nedaru” button, or a purchase request button, which is displayed on an online shopping site, is clicked, a message containing a link to a product page is sent to a person who is requested to make a payment. In the third technique, when the person who receives the payment request clicks the link in the purchase request message, the request recipient is taken to a product page of an e-commerce site. Then, the request recipient is able to process a payment procedure on the page.

Furthermore, a fourth technique is disclosed on the Internet website <URL:http://shop.triumphjapan.com/info/onedari.html>, [searched on Jun. 27, 2010], [online], “About Onedari Function”, by Triumph online shop, in which an “Onedari Cart” is displayed on an online shopping site. In the fourth technique, when a settlement stage is reached after a product is put in the “Onedari Cart”, one-off ID and password and a link to a settlement confirmation screen are generated. Then, the one-off ID and password and the link will be listed in a notification email, and sent to a person who is requested to make a payment. The person receiving the notification email will log in using the one-off ID and password, and proceed with the settlement on the settlement confirmation screen (or reject the payment). As described above, the person receiving the notification email is able to make the payment on behalf of the requester. In the technique, if the notification email is left for two weeks, the information of the “Onedari Cart” is automatically cancelled.

However, in the first technique and the fourth technique, there are no restrictions on the request recipient of payments. Therefore, a user with malicious intent may request any other user to make a payment. Thus, there are concerns about the safety of transactions. In the second technique, it is assumed that the payment requester and the payer are in a family relationship. Therefore, it is not possible to request users in relationships other than a family relationship to make a payment. The third technique is a technique in which a product is introduced to a person receiving a payment request, and the request recipient is encouraged to purchase the product. In this case, the person receiving the request performs a complicated procedure to purchase the product.

### SUMMARY

According to an aspect of the invention, a purchasing service providing method executed by a processor included in a purchasing service providing apparatus, the method includes transmitting, to a second computer, a request for payment delegation in which payment of a price of a product or a service to be purchased through a first computer is delegated to the second computer; receiving a payment request for the payment of the price from the first computer, the payment request including information of a name and the price of the product or the service; transmitting the payment request to the second computer, and conducting processing for the payment using funds corresponding to the second computer when an instruction for conducting the processing for the payment is received from the second computer, when a permission notification indicating that the payment delegation is permitted is received from the second computer and the price is more than a credit limit of the payment; and conducting the processing for the payment using the funds and updating the credit limit based on the price, when the permission notification is received from the second computer and the price is less than or equal to the credit limit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a purchasing service providing apparatus;

FIG. 2 is a block diagram illustrating an example of an e-commerce system;

FIG. 3 is a flowchart of a delegation approval reception process;

FIG. 4 is a flowchart of a delegation approval permission process;

FIG. 5 is a flowchart of an automatic payment reception process;

FIG. 6 is a flowchart of a payment request reception process;

FIG. 7 is a flowchart of a stock reservation process;

FIG. 8 is a flowchart of a payment process;

FIG. 9 is a flowchart of an order process;

FIG. 10 is a diagram illustrating an example of delegation permission information;

FIG. 11 is a diagram illustrating an example of automatic payment information;

FIG. 12 is a diagram illustrating an example of stock information;

FIG. 13 is a diagram illustrating an example of product reservation information;

FIG. 14 is a diagram illustrating an example of shopping cart sharing information;

FIG. 15 is a diagram illustrating an example of payment delegation statement information;

FIG. 16 is a diagram illustrating an example of purchase statement information;

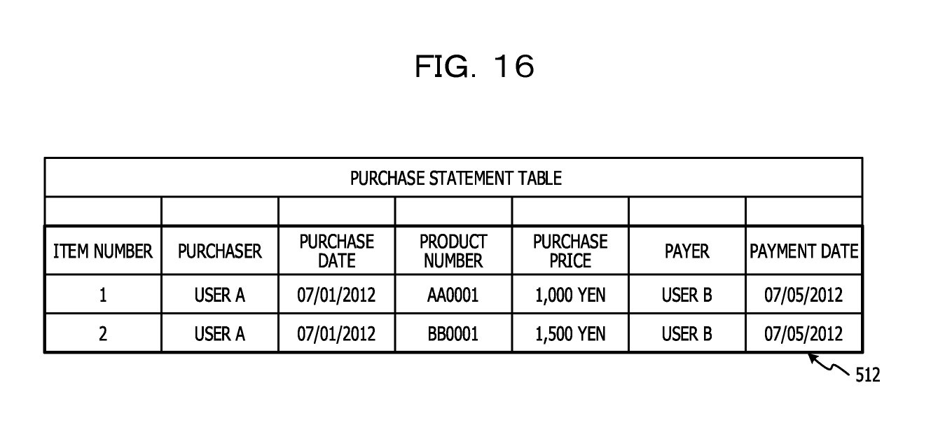

FIG. 17 is a diagram illustrating an example of a payment delegation request selection screen;

FIG. 18 is a diagram illustrating an example of a permission requesting notification screen;

FIG. 19 is a diagram illustrating an example of a payment delegation request screen;

FIG. 20 is a diagram illustrating an example of a permission notification screen;

FIG. 21 is a diagram illustrating an example of an automatic payment information registration screen;

FIG. 22 is a diagram illustrating an example of a deposit completion notification screen;

FIG. 23 is a diagram illustrating an example of a deposit incompletion notification screen;

FIG. 24 is a diagram illustrating an example of a shopping cart display screen;

FIG. 25 is a diagram illustrating an example of a request recipient selection screen;

FIG. 26 is a diagram illustrating an example of a payment requesting screen;

FIG. 27 is a diagram illustrating an example of a stock reservation failure screen;

FIG. 28 is a diagram illustrating an example of a shopping cart display screen;

FIG. 29 is a diagram illustrating an example of a payment method selection screen;

FIG. 30 is a diagram illustrating an example of a payment completion screen;

FIG. 31 is a diagram illustrating an example of a reason input screen;

FIG. 32 is a diagram illustrating an example of a payment rejection notification screen;

FIG. 33 is a diagram illustrating an example of a payment statement display screen;

FIG. 34 is a diagram illustrating an example of a shopping cart display screen;

FIG. 35 is a diagram illustrating an example of a purchase statement screen;

FIG. 36 is a diagram illustrating an example of a payment delegation approval request notification email sent to a user A;

FIG. 37 is a diagram illustrating an example of a payment delegation approval request notification email sent to a user B;

FIG. 38 is a diagram illustrating an example of a payment delegation completion email sent to the user A;

FIG. 39 is a diagram illustrating an example of a payment delegation completion email sent to the user B;

FIG. 40 is a diagram illustrating an example of a payment delegation cancellation email sent to the user A;

FIG. 41 is a diagram illustrating an example of a payment delegation cancellation email sent to the user B;

FIG. 42 is a diagram illustrating an example of a payment delegation expiry email sent to the user B;

FIG. 43 is a diagram illustrating an example of a deposit completion notification email sent to the user B;

FIG. 44 is a diagram illustrating an example of a deposit incompletion notification email sent to the user B;

FIG. 45 is a diagram illustrating an example of a payment request notification email sent to the user A;

FIG. 46 is a diagram illustrating an example of a payment request notification email sent to the user B;

FIG. 47 is a diagram illustrating an example of a payment completion notification email sent to the user A;

FIG. 48 is a diagram illustrating an example of a payment completion notification email sent to the user B;

FIG. 49 is a diagram illustrating an example of a payment rejection notification email sent to the user A;

FIG. 50 is a diagram illustrating an example of a payment rejection notification email sent to the user B; and

FIG. 51 is a diagram illustrating an example of a shopping cart display screen when a plurality of users receive payment delegations.

### DESCRIPTION OF EMBODIMENTS

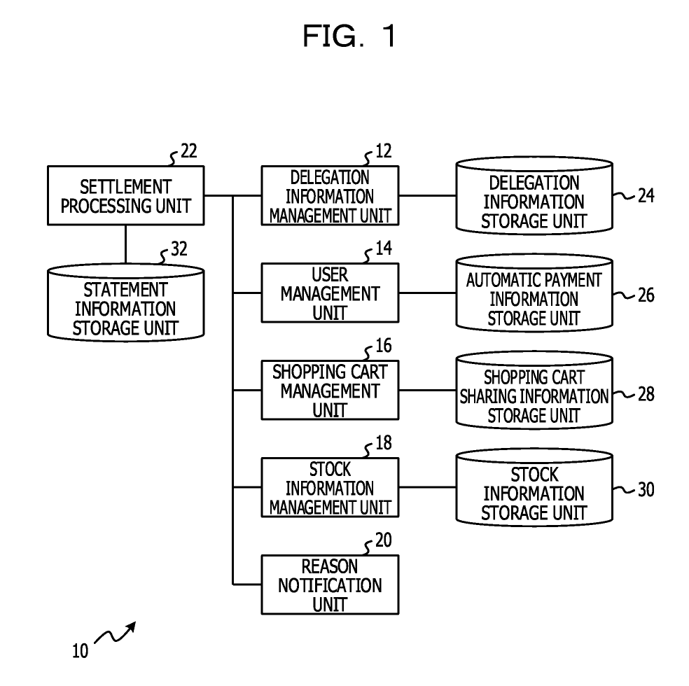

Hereinafter, examples of embodiments of disclosed techniques will be described in detail with reference to the accompanying drawings. FIG. 1 is a diagram illustrating an example of a purchasing service providing apparatus 10 according to an embodiment. The purchasing service providing apparatus 10 includes a delegation information management unit 12, a user management unit 14, a shopping cart management unit 16, a stock information management unit 18, a reason notification unit 20, a settlement processing unit 22, a delegation information storage unit 24, an automatic payment information storage unit 26, and a shopping cart sharing information storage unit 28. The purchasing service providing apparatus 10 also includes a stock information storage unit 30 and a statement information storage unit 32.

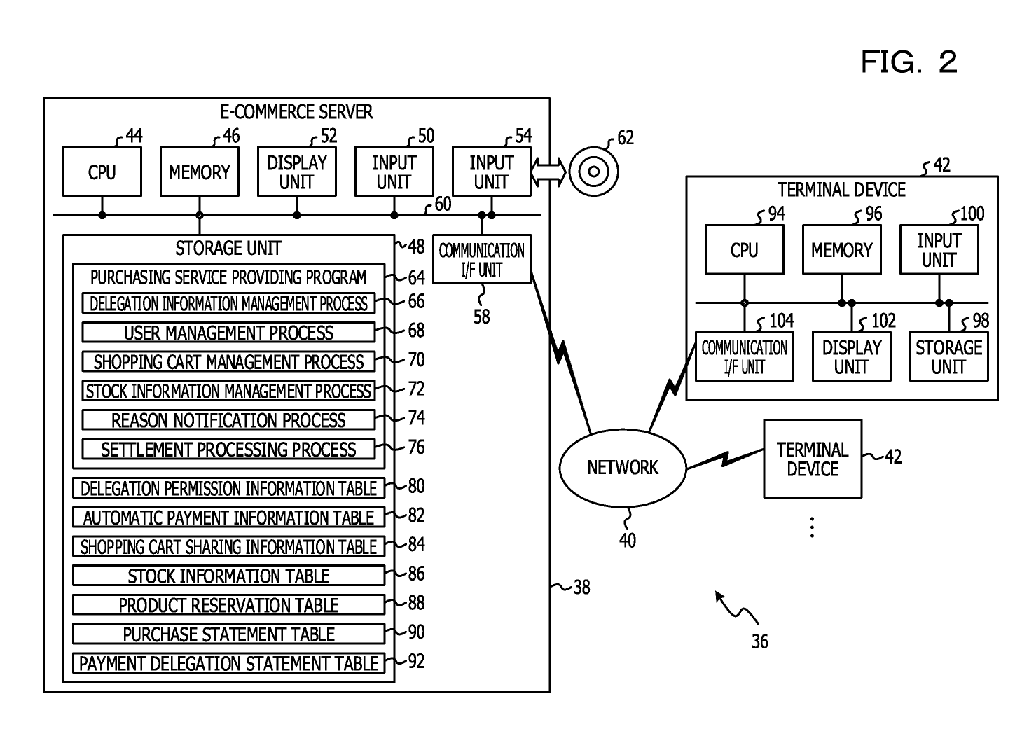

The delegation information management unit 12 queries a second user as to permission for payment delegation in which payment for a product that a first user wants to purchase is delegated to the second user. When the payment delegation is permitted by the second user, the delegation information management unit 12 performs processing for setting delegation permission information in a delegation permission information table 80 (see FIG. 2). The delegation permission information table 80 is stored in the delegation information storage unit 24.

In the case where the credit limit for automatic payment in the case of payment delegation is input by the second user, the user management unit 14 performs processing for setting automatic payment information, which includes the input credit limit, in an automatic payment information table 82 (see FIG. 2). The automatic payment information table 82 is stored in the automatic payment information storage unit 26.

The shopping cart management unit 16 performs the processing described below in the case where the second user is requested by the first user to pay for a product that the first user wants to purchase and corresponding delegation permission information is stored in the delegation information storage unit 24. That is, the shopping cart management unit 16 displays a shopping cart list including the name, the quantity, and the price of a product that the first user wants to purchase on a display device to be browsed by the second user. Then, the shopping cart management unit 16 requests the second user to make a payment.

The shopping cart list may be displayed on the display device to be browsed by the second user when the shopping cart list is shared between the first user and the second user. The shopping cart management unit 16 sets shopping cart sharing information, which includes information indicating that the shopping cart list is shared between the first user and the second user, in a shopping cart sharing information table 84 (see FIG. 2). The shopping cart sharing information table 84 is stored in the shopping cart sharing information storage unit 28.

In the case where the second user is requested by the first user to pay for a product that the first user wants to purchase, the stock information management unit 18 subtracts the quantity of the product described in the shopping cart list from the stock quantity in a stock information table 86 (see FIG. 2). The stock information management unit 18 performs processing for provisionally reserving the product by registering to a product reservation table 88 (see FIG. 2) the product corresponding to the quantity described in the shopping cart list in a provisionally reserved state. The stock information table 86 and the product reservation table 88 are stored in the stock information storage unit 30.

In the case where the payment for a product or a service listed in the shopping cart list displayed on the display device browsed by the second user is rejected by the second user, the reason notification unit 20 displays on the display device a reason input screen for inputting the reason for the rejection of the payment. Then, the reason notification unit 20 notifies the first user of the reason for the payment rejection input on the reason input screen.

The settlement processing unit 22 performs the processing described below in the case where an instruction to pay for a product listed with the name, quantity, and price on the shopping cart list displayed on the display device browsed by the second user is given by the second user. That is, the settlement processing unit 22 performs settlement processing for settling the price of the product based on funds of the second user and sets purchase statement information in a purchase statement table 90 stored in the statement information storage unit 32. Then, the settlement processing unit 22 sets payment delegation statement information in a payment delegation statement table 92.

The purchasing service providing apparatus 10 may be implemented by an e-commerce server 38 included in an e-commerce system 36 illustrated in FIG. 2. The e-commerce system 36 includes the e-commerce server 38 and a plurality of terminal devices 42 connected to the e-commerce server 38 via a network 40 such as the Internet.

The e-commerce server 38 includes a central processing unit (CPU) 44, a memory 46, a storage unit 48, an input unit 50, a display unit 52, a medium read/write device (R/W) 54, and a communication interface (I/F) unit 58. The CPU 44, the memory 46, the storage unit 48, the input unit 50, the display unit 52, and the medium read/write device 54 are connected to each other via a bus 60. The medium read/write device 54 reads information written in a recording medium 62, and writes information to the recording medium 62.

The storage unit 48 is implemented by a hard disk drive (HDD), a flash memory, or the like. The storage unit 48 stores a purchasing service providing program 64 for causing the e-commerce server 38 to function as the purchasing service providing apparatus 10. The purchasing service providing program 64 is stored into the storage unit 48 when the medium read/write device 54 reads the purchasing service providing program 64 from the recording medium 62, which stores thereon the purchasing service providing program 64 and set in the medium read/write device 54. The CPU 44 reads the purchasing service providing program 64 from the storage unit 48 and develops the purchasing service providing program 64 in the memory 46. Then, the CPU 44 sequentially executes processes provided in the purchasing service providing program 64.

The purchasing service providing program 64 executes a delegation information management process 66, a user management process 68, a shopping cart management process 70, a stock information management process 72, a reason notification process 74, and a settlement processing process 76. The CPU 44 operates as the delegation information management unit 12 illustrated in FIG. 1 by executing the delegation information management process 66. The CPU 44 operates as the user management unit 14 illustrated in FIG. 1 by executing the user management process 68. The CPU 44 operates as the shopping cart management unit 16 illustrated in FIG. 1 by executing the shopping cart management process 70. The CPU 44 operates as the stock information management unit 18 illustrated in FIG. 1 by executing the stock information management process 72. The CPU 44 operates as the reason notification unit 20 illustrated in FIG. 1 by executing the reason notification process 74. The CPU 44 operates as the settlement processing unit 22 illustrated in FIG. 1 by executing the settlement processing process 76. Accordingly, the e-commerce server 38 executing the purchasing service providing program 64 functions as the purchasing service providing apparatus 10. The purchasing service providing program 64 is an example of a purchasing service providing program according to a disclosed technique.

The storage unit 48 stores the delegation permission information table 80, the automatic payment information table 82, the shopping cart sharing information table 84, the stock information table 86, the product reservation table 88, the purchase statement table 90, and the payment delegation statement table 92. Accordingly, the storage unit 48 functions as the delegation information storage unit 24, the automatic payment information storage unit 26, the shopping cart sharing information storage unit 28, the stock information storage unit 30, and the statement information storage unit 32. The purchasing service providing apparatus 10 may also be implemented by, for example, a semiconductor integrated circuit, or more specifically, an application specific integrated circuit (ASIC) or the like.

In contrast, the terminal device 42 includes a CPU 94, a memory 96, a storage unit 98, an input unit 100, a display unit 102, and a communication interface (I/F) unit 104. As the terminal device 42, for example, a personal computer (PC) or a smart terminal, which is a portable-type information processing device having functions of a portable information terminal (personal digital assistants (PDA)), may be used. A browser (browsing software) is installed in the storage unit 98.

Hereinafter, operations of the embodiment will be described. The e-commerce server 38 introduces, via the network 40, sales products and manages a product sales website for receiving product orders from users. On the product sales website managed by the e-commerce server 38, product price settlement may be carried out through payment delegation in which payment of the price of a product that a first user (a user A) wants to purchase is delegated to a second user (a user B).

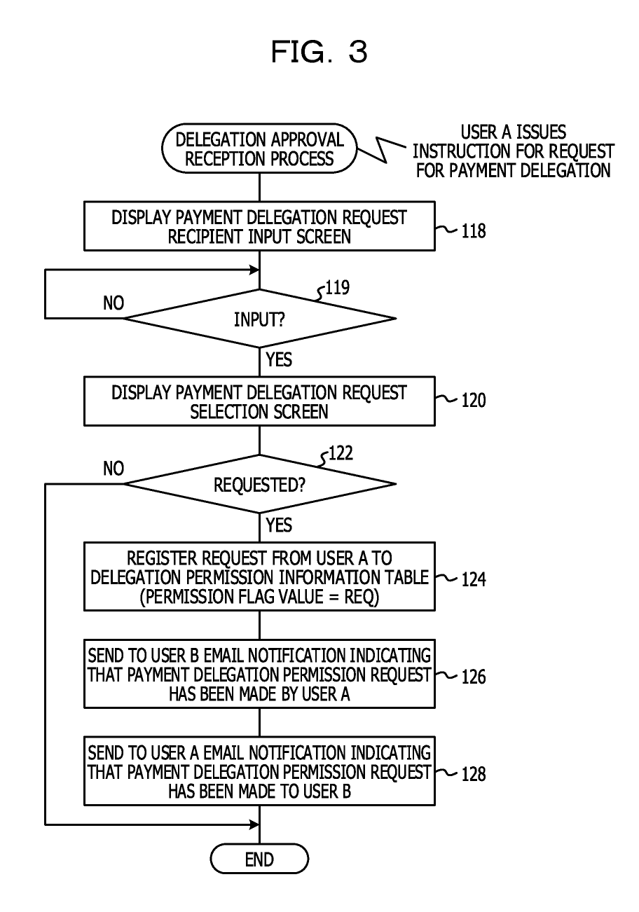

When using payment delegation, the user A starts a browser on the terminal device 42. The user A performs such an operation as specifying a uniform resource locator (URL), and accesses the product sales website. The home page of the product sales website is thus distributed from the e-commerce server 38 to the terminal device 42 operated by the user A. Then, the home page of the product sales website is displayed on the display unit 102. In the home page displayed on the display unit 102, an option for issuing an instruction to make a request for payment delegation is displayed. The user A issues, by selecting the option, an instruction to make a request for payment delegation. With the operation as a trigger, a delegation approval reception process illustrated in FIG. 3 is executed on the e-commerce server 38.

In step 118 of the delegation approval reception process, the delegation information management unit 12 distributes, to the terminal device 42 operated by the user A, a payment delegation request recipient input screen which includes an input field for inputting information identifying a request recipient to whom payment delegation is to be requested. Thus, the payment delegation request recipient input screen is displayed on the display unit 102 of the terminal device 42 operated by the user A.

In next step 119, the delegation information management unit 12 determines whether or not information for identifying the request recipient to whom payment delegation is to be requested is input through the payment delegation request recipient input screen. The delegation information management unit 12 repeats step 119 until an affirmative result is obtained in the determination in step 119. When the payment delegation request recipient input screen is displayed on the display unit 102 of the terminal device 42, the user A inputs information for identifying the request recipient to whom payment delegation is to be requested (the user B) in the input field of the screen. Thus, an affirmative result is obtained in the determination in step 119, and the process proceeds to step 120.

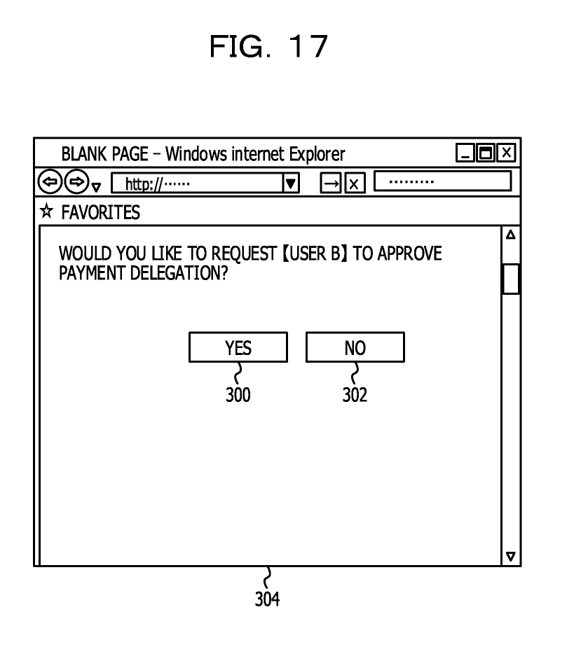

In step 120, as illustrated in FIG. 17, the delegation information management unit 12 distributes, to the terminal device 42, a payment delegation request selection screen 304, which specifies the user B as the request recipient to whom the payment delegation is to be requested and which includes buttons 300 and 302 for selecting whether or not to make a request to the user B for permission for payment delegation. Thus, on the display unit 102 of the terminal device 42 operated by the user A, the payment delegation request selection screen 304 is displayed.

In next step 122, the delegation information management unit 12 determines, through the payment delegation request selection screen 304, whether or not a request for permission for payment delegation has been made. When the payment delegation request selection screen 304 is displayed on the display unit 102 of the terminal device 42, the user A performs selection of either the button 300 or the button 302. If the user A performs selection of the button 302 for not requesting permission for payment delegation, a negative result is obtained in the determination in step 122, and the delegation approval reception process ends.

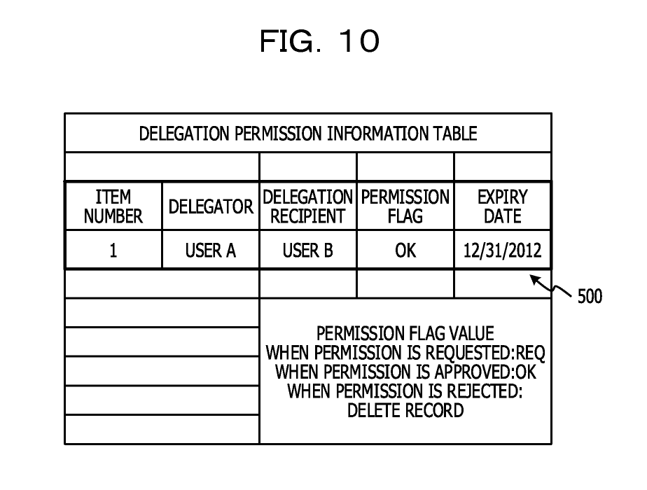

On the other hand, when the user A performs selection of the button 300 for requesting permission for payment delegation, an affirmative result is obtained in the determination in step 122, and the process proceeds to step 124. In step 124, the delegation information management unit 12 registers the request from the user A as information to a delegation permission information table 500 illustrated in FIG. 10.

The delegation permission information table 500 is provided with fields: “item number”, “delegator”, “delegation recipient”, “permission flag”, and “expiry date”. In the delegation permission information table 500, relevant information is set for each record. Information identifying a requester of payment delegation is set as the “delegator”, and information identifying a request recipient of payment delegation is set as the “delegation recipient”. As the “permission flag”, “REQ” is set at the time of permission request, and “OK” is set at the time of permission approval. The expiry date for payment delegation is set as the “expiry date”. For example, when the user A requests the user B to permit payment delegation, information identifying the user A is set as the “delegator”, and information identifying the user B is set as the “delegation recipient”. Further, “REQ” is set as the “permission flag”, and the expiry date of the payment delegation is set as the “expiry date”.

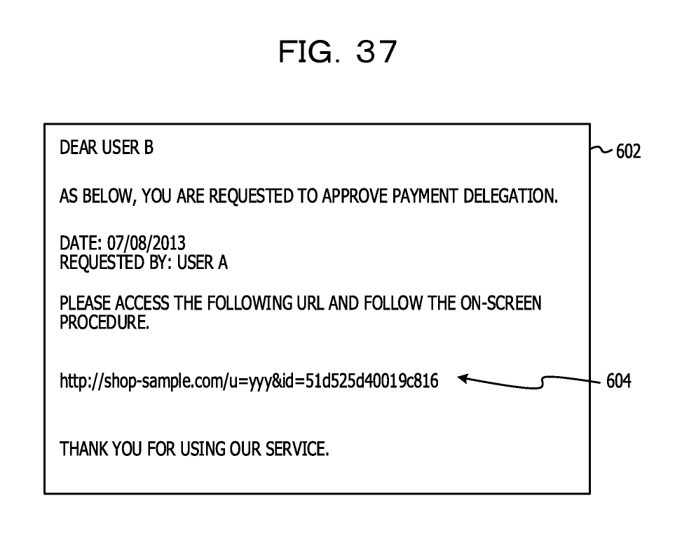

In next step 126, the delegation information management unit 12 sends a payment delegation approval request notification email 602 to the user B, for example, as illustrated in FIG. 37. The payment delegation approval request notification email 602 states that a payment delegation permission request has been made by the user A. The user B performs an email receiving operation to read the contents of the payment delegation approval request notification email 602. Accordingly, the user B is notified that a payment delegation permission request has been made by the user A.

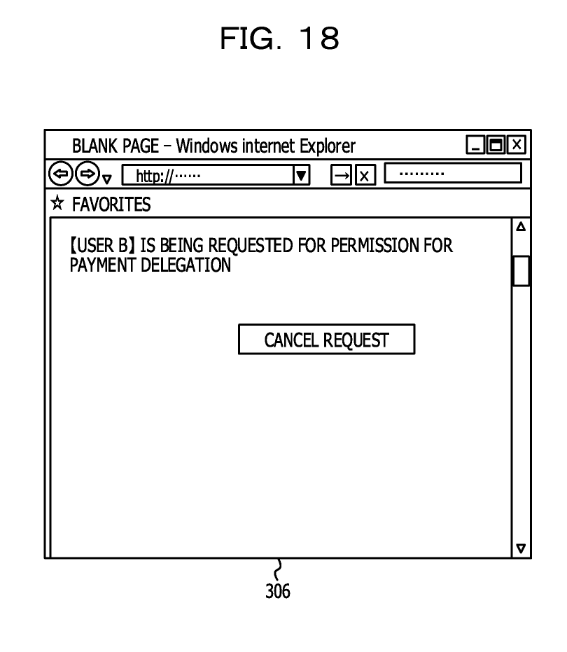

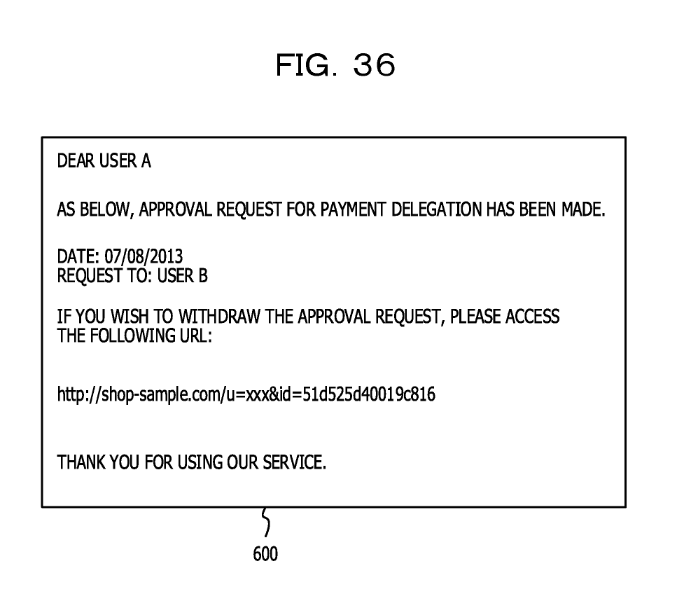

In step 128, the delegation information management unit 12 sends a payment delegation approval request notification email 600 to the user A, for example, as illustrated in FIG. 36. The payment delegation approval request notification email 600 states that a payment delegation permission request has been made to the user B. The user A performs an email receiving operation to read the contents of the payment delegation approval request notification email 600. Accordingly, the user A is notified that the payment delegation permission request has been made to the user B. As illustrated in FIG. 18, the delegation information management unit 12 distributes, to the terminal device 42 operated by the user A, a permission requesting notification screen 306 for notifying that a payment delegation permission request to the user B is under way. Thus, on the display unit 102 of the terminal device 42 operated by the user A, the permission requesting notification screen 306 is displayed.

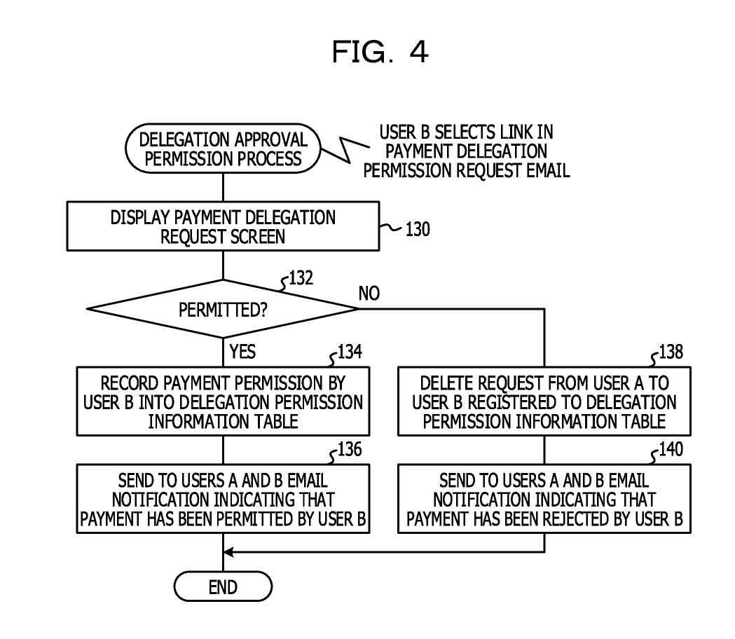

To the payment delegation approval request notification email 602 to be sent to the user B, a link 604 to a payment delegation request screen of the product sales website is attached. When the user B acknowledges the contents of the payment delegation approval request notification email 602 and performs selection of the link 604, a browser is started on the terminal device 42 operated by the user B, and the payment delegation request screen of the product sales website is accessed. With the operation as a trigger, a delegation approval permission process illustrated in FIG. 4 is executed on the e-commerce server 38.

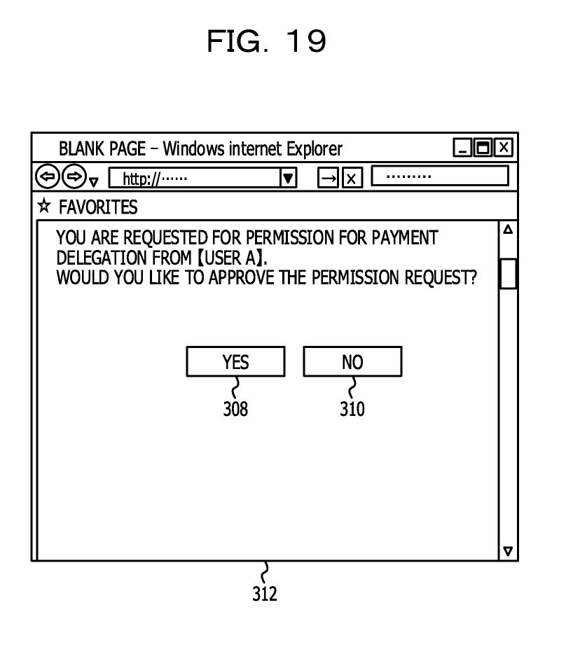

In step 130 of the delegation approval permission process, the delegation information management unit 12 distributes a payment delegation request screen 312 illustrated in FIG. 19 to the terminal device 42 operated by the user B. On the payment delegation request screen 312, the user A is specified as a delegator, and buttons 308 and 310 are provided for selecting whether or not to permit the payment delegation. As described above, the payment delegation request screen 312 is displayed on the display unit 102 of the terminal device 42 operated by the user B.

In next step 132, the delegation information management unit 12 determines, through the payment delegation request screen 312, whether or not the payment delegation has been permitted. When the payment delegation request screen 312 is displayed on the display unit 102 of the terminal device 42, the user B performs selection of either the button 308 or the button 310. When the user B performs selection of the button 308 for permitting the payment delegation, an affirmative result is obtained in the determination in step 132, and the process proceeds to step 134.

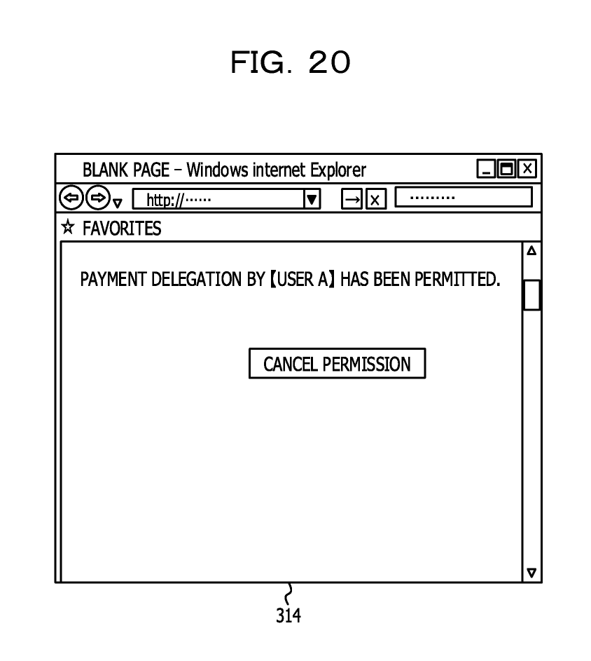

In step 134, by setting “OK” for the “permission flag” of the delegation permission information table 500 (FIG. 10), the delegation information management unit 12 records that the payment delegation has been permitted by the user B. As illustrated in FIG. 20, the delegation information management unit 12 distributes, to the terminal device 42 operated by the user B, a permission notification screen 314 for notifying that the payment delegation has been permitted. Accordingly, the permission notification screen 314 is displayed on the display unit 102 of the terminal device 42 operated by the user B.

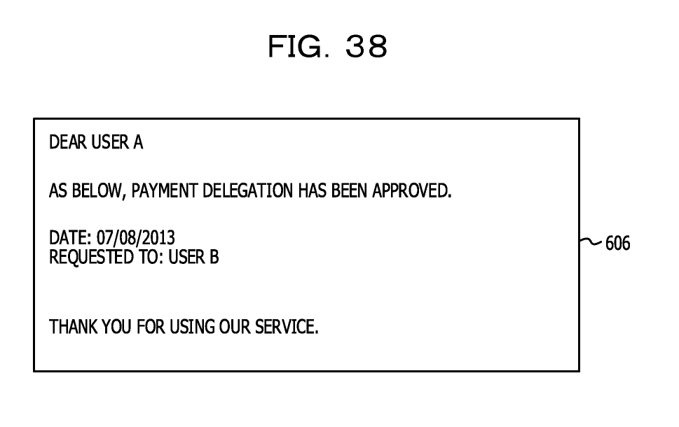

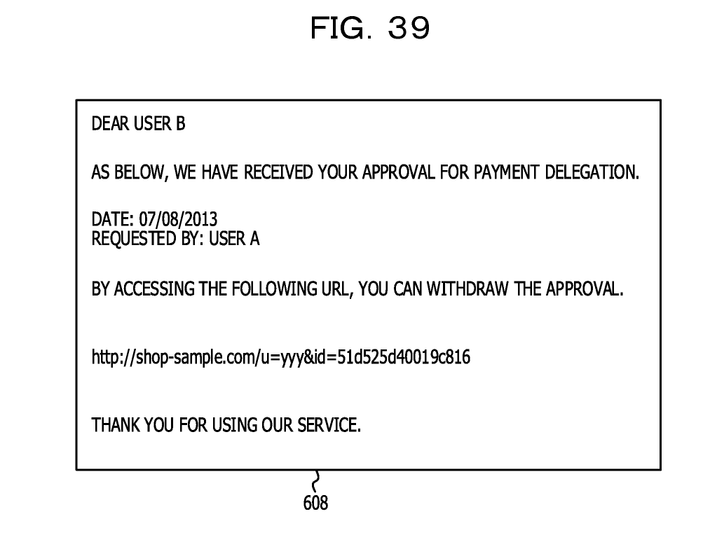

In next step 136, the delegation information management unit 12 sends a payment delegation completion email 606 to the user A, for example, as illustrated in FIG. 38, and a payment delegation completion email 608 to the user B, for example, as illustrated in FIG. 39. Then, the delegation approval permission process ends. Both the payment delegation completion emails 606 and 608 state that the user B has permitted the payment delegation. The user A performs an email receiving operation to read the contents of the payment delegation completion email 606. Accordingly, the user A is notified that the user B has permitted the payment delegation. The user B performs an email receiving operation to read the contents of the payment delegation completion email 608. Accordingly, the user B confirms that he/she has permitted the payment delegation.

On the other hand, when the user B performs selection of the button 310 for rejecting the payment delegation in step 132, a negative determination is obtained in the determination in step 132, and the process proceeds to step 138. In step 138, the delegation information management unit 12 deletes from the delegation permission information table 500 (FIG. 10) a record corresponding to the payment delegation to the user B from the user A.

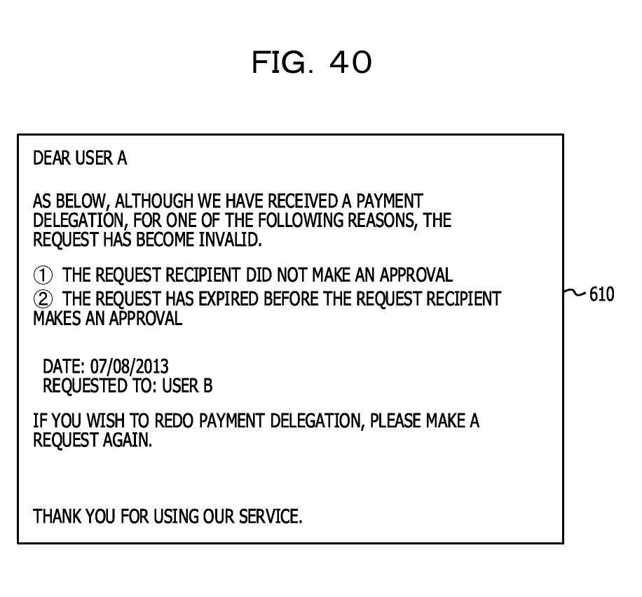

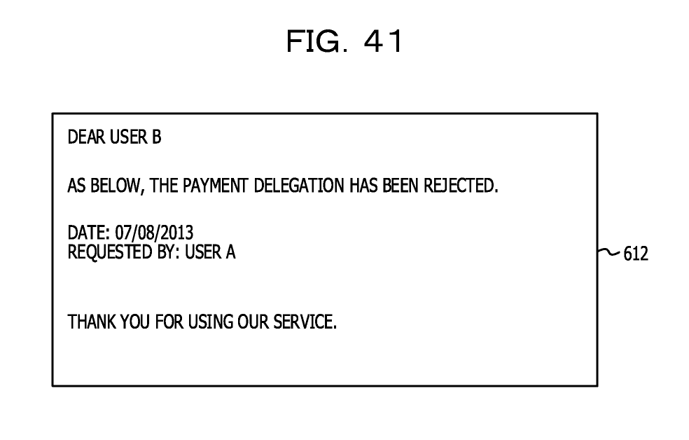

In next step 140, the delegation information management unit 12 sends a payment delegation cancellation email 610 to the user A, for example, as illustrated in FIG. 40, and a payment delegation cancellation email 612 to the user B, for example, as illustrated in FIG. 41. Then, the delegation approval permission process ends. The payment delegation cancellation email 610 states that the payment delegation request has become invalid. The payment delegation cancellation email 610 states that the reason for the invalidity is disapproval by the request recipient or expiration of the payment delegation. The user A performs an email receiving operation to read the contents of the payment delegation cancellation email 610. Accordingly, the user A is notified that the user B has disapproved the payment delegation. The payment delegation cancellation email 612 states that the payment delegation has been rejected. The user B performs an email receiving operation to read the contents of the payment delegation cancellation email 612. Accordingly, the user B confirms that he/she has rejected the payment delegation.

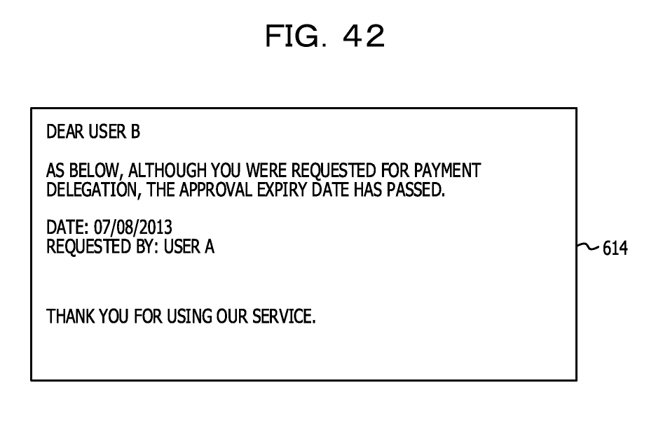

An expiry date is set for payment delegation. When the user B does not perform selection of the link 604 attached to the contents of the payment delegation approval request notification email 602 before the expiry date, the payment delegation expires. With the fact that the payment delegation has expired as a trigger, the delegation information management unit 12 sends the payment delegation cancellation email 610 (FIG. 40) to the user A, and a payment delegation expiry email 614 to the user B, for example, as illustrated in FIG. 42.

Both the payment delegation cancellation email 610 and the payment delegation expiry email 614 state that the payment delegation has expired. The user A performs an email receiving operation to read the contents of the payment delegation cancellation email 610. Accordingly, the user A is notified that the payment delegation has expired. The user B performs an email receiving operation to read the contents of the payment delegation expiry email 614. Accordingly, the user B is notified that the payment delegation request from the user A has expired.

In the embodiment, the user B who permits the payment delegation may set the credit limit for automatic payment and perform payment settlement processing in advance. Thus, it is possible to conduct automatic payment in which a payment of the price of a product less than the credit limit is made automatically.

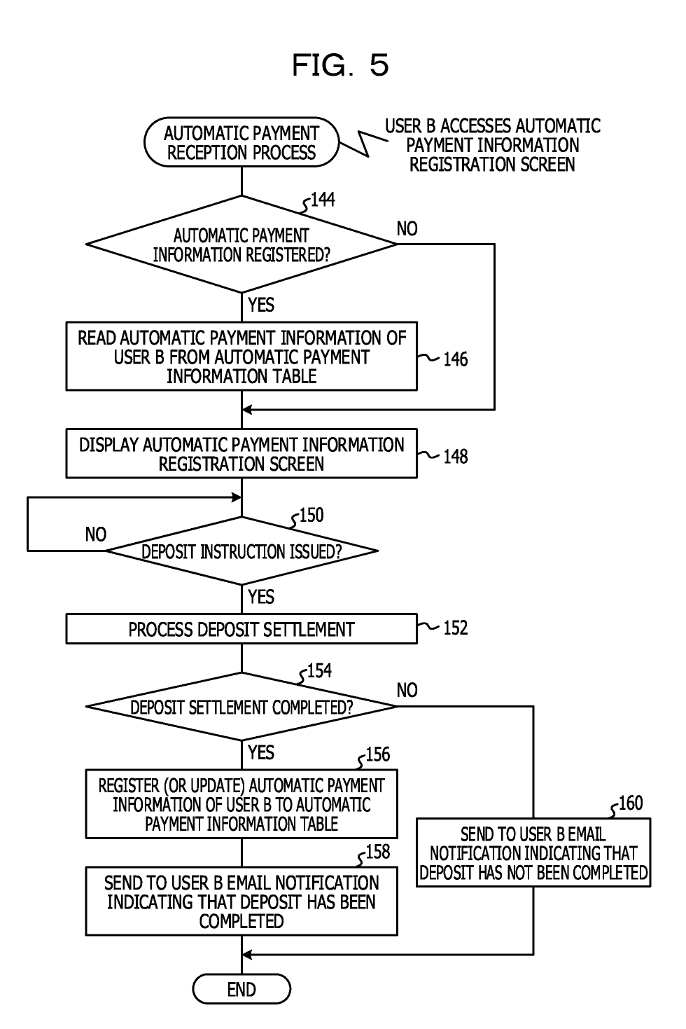

When setting automatic payment, the user B starts a browser on the terminal device 42, and performs an operation for specifying an URL and the like to access a product sales website. Accordingly, the home page of the product sales website is distributed from the e-commerce server 38 to the terminal device 42 operated by the user B, and the home page of the product sales website is displayed on the display unit 102. In the home page displayed on the display unit 102, an option for setting automatic payment is displayed. The user B selects the option to issue an instruction to set automatic payment. With the operation as a trigger, an automatic payment reception process illustrated in FIG. 5 is executed by the e-commerce server 38.

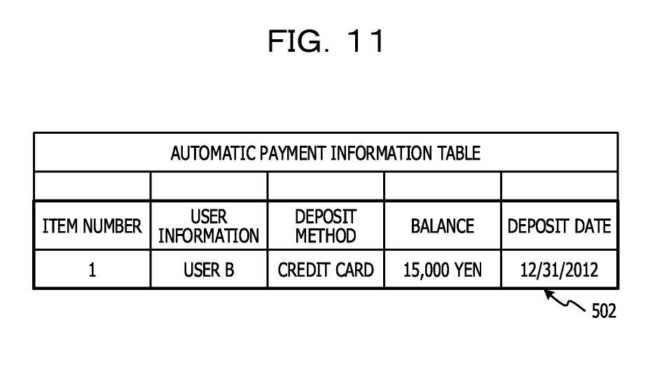

In step 144 of the automatic payment reception process, the user management unit 14 determines whether or not automatic payment information corresponding to the user B, who is a person who has issued an instruction to set automatic payment, has been registered in an automatic payment information table 502 (see FIG. 11) stored in the automatic payment information storage unit 26. The automatic payment information table 502 is provided with fields: “item number”, “user information”, “deposit method”, “balance”, and “deposit date”, and relevant information is set for each record. Information identifying the person who has issued the instruction to set automatic payment is set as the “user information”, and information identifying the deposit method of funds used for the automatic payment is set as the “deposit method”. The balance of funds used for the automatic payment is set as the “balance”, and the deposit date of funds used for the automatic payment is set as the “deposit date”.

When automatic payment information corresponding to the user B has been registered in the automatic payment information table 502, an affirmative result is obtained in the determination in step 144, and the process proceeds to step 146. In step 146, the user management unit 14 reads the automatic payment information corresponding to the user B from the automatic payment information table 502, and the process proceeds to step 148. When the automatic payment information corresponding to the user B has not been registered in the automatic payment information table 502, a negative result is obtained in the determination in step 144, and the process proceeds to step 148.

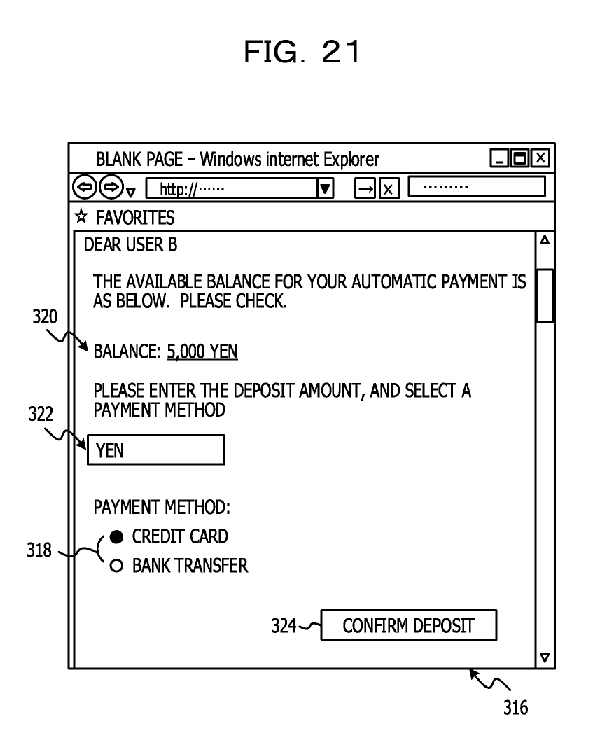

In step 148, the user management unit 14 distributes to the terminal device 42 operated by the user B an automatic payment information registration screen 316, for example, as illustrated in FIG. 21. Accordingly, the automatic payment information registration screen 316 is displayed on the display unit 102 of the terminal device 42 operated by the user B. The automatic payment information registration screen 316 is provided with a radio button 318 for selecting a payment method (deposit method) of funds used for automatic payment. The automatic payment information registration screen 316 is provided with an input field 322 for inputting a deposit amount and a button 324 for issuing an instruction for a deposit. When the automatic payment information corresponding to the user B has been registered in the automatic payment information table 502, a character string 320 indicating the balance of funds used for automatic payment is displayed on the automatic payment information registration screen 316.

In next step 150, the user management unit 14 determines, through the automatic payment information registration screen 316, whether or not an instruction for a deposit has been issued. When setting automatic payment, the user B inputs a deposit amount into the input field 322. Then, the user B selects a payment method (deposit method) by the radio button 318 and presses the button 324. When the user B performs the selection of the button 324, an affirmative result is obtained in the determination in step 150, and the process proceeds to step 152. In step 152, the user management unit 14 performs deposit settlement processing for depositing the deposit amount of funds input in the input field 322, by the payment method (deposit method) selected by the radio button 318.

In next step 154, the user management unit 14 determines whether or not the deposit settlement processing in step 152 has been successfully completed. When an affirmative result is obtained in the determination in step 154, the process proceeds to step 156. In step 156, the user management unit 14 registers the automatic payment information of the user B to the automatic payment information table 502 or updates the automatic payment information of the user B registered in the automatic payment information table 502. For example, when the user B newly makes a deposit through a credit card, information identifying the user B is set as the “user information”, and “credit card” is set as the “deposit method”. Further, the deposit amount is set as the “balance”, and the deposit date is set as the “deposit date”.

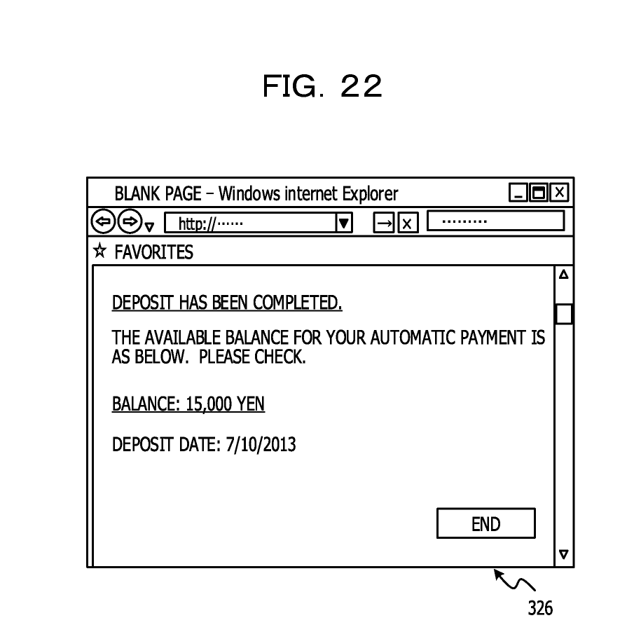

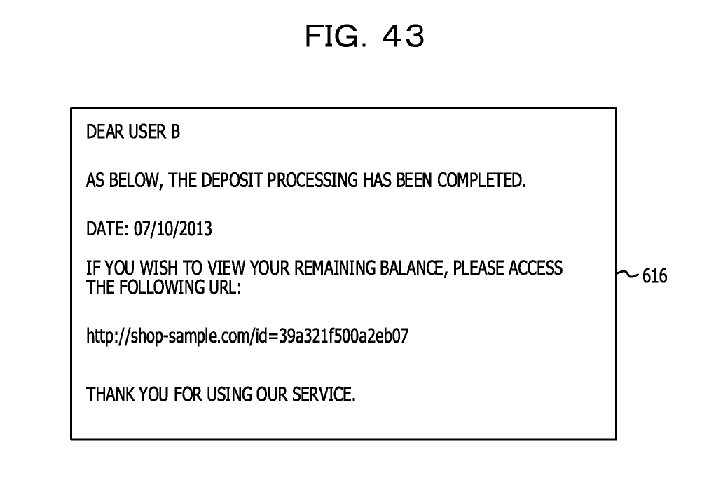

In next step 158, the delegation information management unit 12 performs processing for notifying the user B that deposit processing has been completed. That is, as illustrated in FIG. 22, the delegation information management unit 12 distributes, to the terminal device 42 operated by the user B, a deposit completion notification screen 326 which notifies that the deposit processing has been completed. Accordingly, the deposit completion notification screen 326 is displayed on the display unit 102 of the terminal device 42 operated by the user B. The delegation information management unit 12 sends a deposit completion notification email 616 to the user B, for example, as illustrated in FIG. 43, and the automatic payment reception process ends. The deposit completion notification email 616 states that the deposit processing has been completed. The user B browses the deposit completion notification screen 326, and performs an email receiving operation to read the contents of the deposit completion notification email 616. Accordingly, the user B is notified that the deposit processing has been completed.

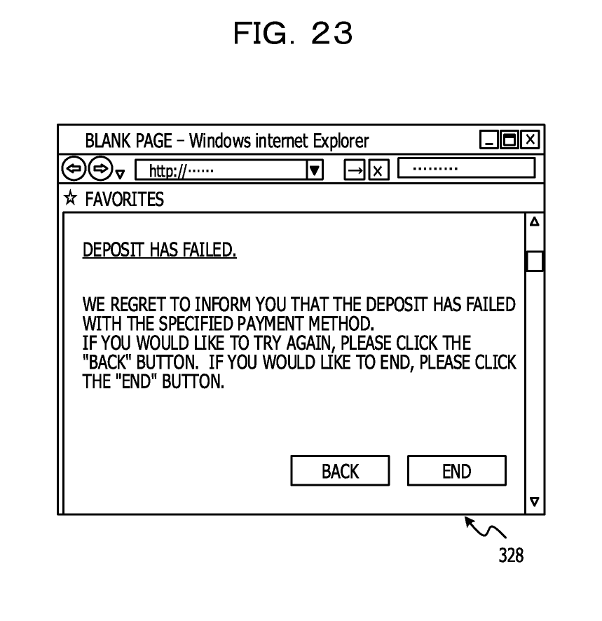

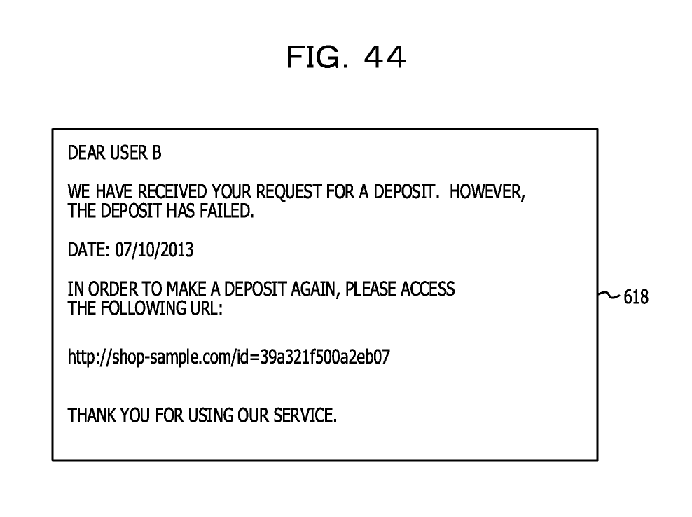

In the case where the deposit settlement processing in step 152 has not been successfully completed (a deposit has failed), a negative result is obtained in the determination in step 154, and the process proceeds to step 160. In step 160, the user management unit 14 performs processing for notifying the user B that a deposit has failed. That is, as illustrated in FIG. 23, the delegation information management unit 12 distributes, to the terminal device 42 operated by the user B, a deposit incompletion notification screen 328 which notifies that the deposit has failed. Accordingly, the deposit incompletion notification screen 328 is displayed on the display unit 102 of the terminal device 42 operated by the user B. The delegation information management unit 12 sends a deposit incompletion notification email 618 to the user B, for example, as illustrated in FIG. 44, and the automatic payment reception process ends. The deposit incompletion notification email 618 states that the deposit has failed. The user B browses the deposit incompletion notification screen 328, and performs an email receiving operation to read the contents of the deposit incompletion notification email 618. Accordingly, the user B is notified that the deposit has failed.

When purchasing a sales product from a product sales website, the user A starts a browser on the terminal device 42, and accesses a product introduction page in which individual products are introduced on the product sales website. Accordingly, a product introduction page is distributed from the e-commerce server 38 to the terminal device 42 operated by the user A, and the product introduction page is displayed on the display unit 102 of the terminal device operated by the user A. When the user A wants to purchase a product introduced in the product instruction page displayed on the display unit 102, the user A inputs, through the input unit 100 or the like, purchase application information including the quantity of the product that the user A wants to purchase.

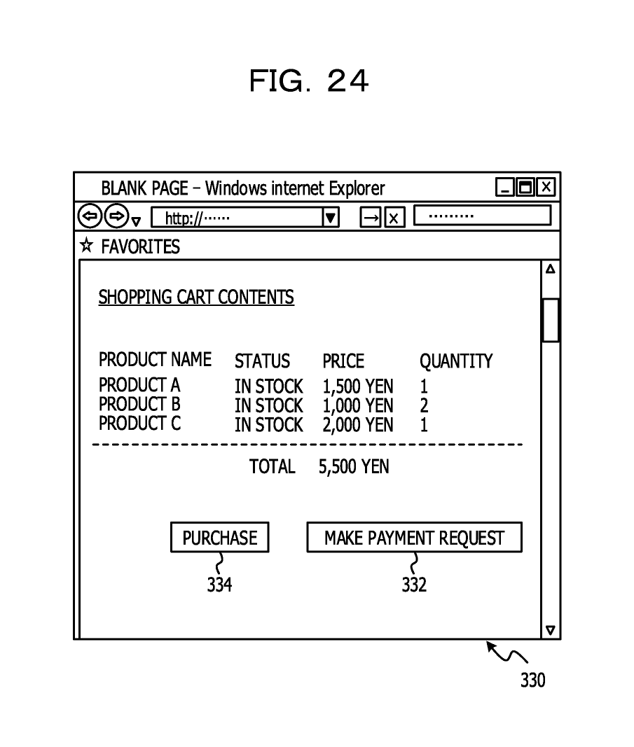

Every time purchase application information is input by the user A, the e-commerce server 38 registers information to a product for which purchase is applied through purchase application information in a shopping cart corresponding to the user A. Then, the e-commerce server 38 generates, for example, as illustrated in FIG. 24, a shopping cart display screen 330 which displays the contents of the shopping cart, and performs processing for distributing the generated shopping cart display screen 330 to the terminal device 42 operated by the user A. Accordingly, the shopping cart display screen 330 is displayed on the display unit 102 of the terminal device 42 operated by the user A.

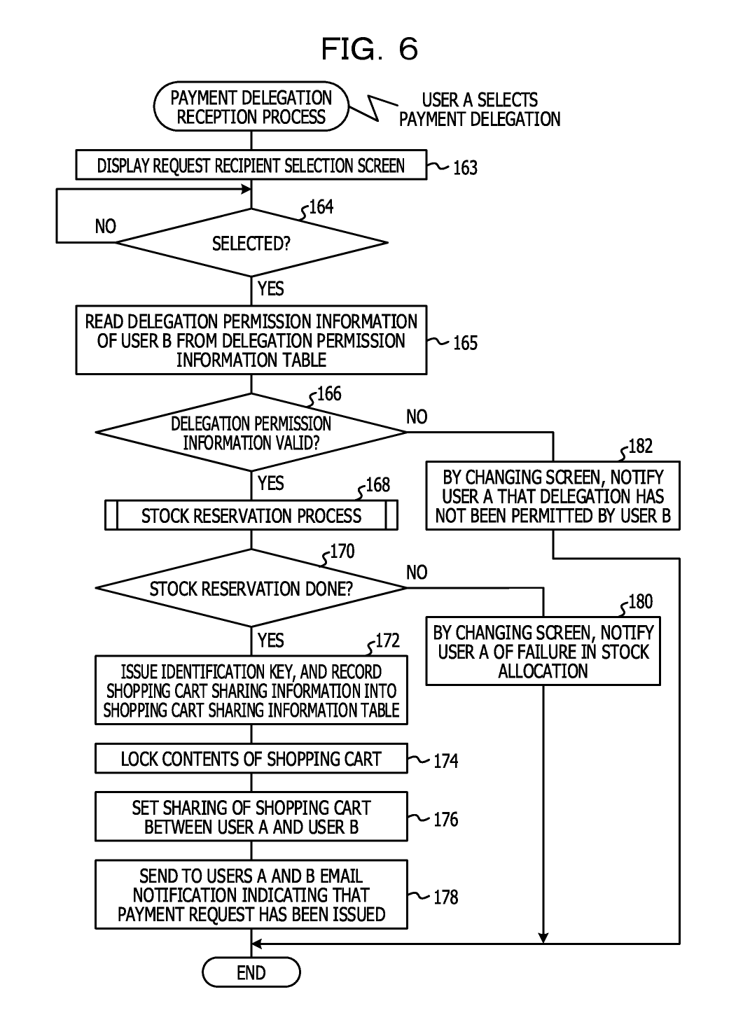

On the shopping cart display screen 330, the product name, status (presence of absence of stock), price, and quantity of all the products in the shopping cart are displayed. The shopping cart display screen 330 is provided with a button 334 for making a payment for the product in the shopping cart by the user himself/herself and a button 332 for using payment delegation in which payment for the product in the shopping cart is requested to a different user. When the user A selects the button 334, the process proceeds to ordinary payment processing in which the user A pays the price of the product. On the other hand, when the user A selects the button 332, a payment delegation reception process illustrated in FIG. 6 is executed by the e-commerce server 38.

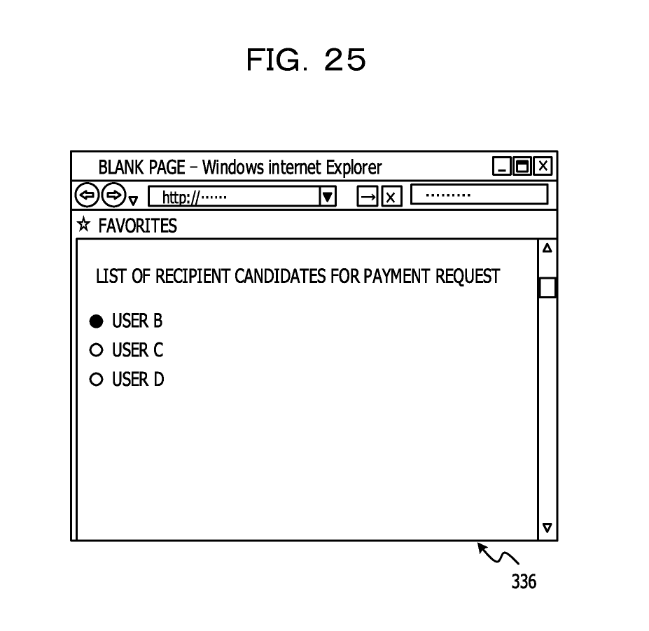

In step 163 of the payment delegation reception process, the shopping cart management unit 16 searches for delegation permission information in which information identifying the user A is set as a “delegator”, from among delegation permission information stored in the delegation permission information table 500. Then, the shopping cart management unit 16 generates, as illustrated in FIG. 25, a request recipient selection screen 336, which displays, as options, users set as “request recipients” in the delegation permission information extracted through the search. Then, the shopping cart management unit 16 distributes the generated request recipient selection screen 336 to the terminal device 42 operated by the user A. Accordingly, the request recipient selection screen 336 is displayed on the display unit 102 of the terminal device 42 operated by the user A.

In next step 164, the shopping cart management unit 16 determines which user, among the users displayed as options on the request recipient selection screen 336, has been selected as a request recipient of payment delegation. Then, the shopping cart management unit 16 repeats step 164 until an affirmative result is obtained in the determination in step 164. When the request recipient selection screen 336 is displayed on the display unit 102 of the terminal device 42 operated by the user A, the user A performs selection of a user to whom payment delegation is to be requested, from among the users displayed as the options on the request recipient selection screen 336. When the user A performs the operation, an affirmative result is obtained in the determination in step 164, and the process proceeds to step 165.

In step 165, the shopping cart management unit 16 reads, from the delegation permission information table 500, delegation permission information of the user (user B) selected as the request recipient of the payment delegation. Then, in step 166, the shopping cart management unit 16 determines, based on whether or not “OK” is set as the “permission flag” of the delegation permission information read in step 165, whether or not the read delegation permission information is valid.

In the case where “REQ” is set as the “permission flag” of the delegation permission information read in step 165, the user as the request recipient of the payment delegation has not permitted the payment delegation. Therefore, it is determined that the read delegation permission information is invalid and a negative result is obtained in the determination in step 166. In such a case, the process proceeds to step 182. In step 182, the shopping cart management unit 16 displays a screen notifying the user A that the user B has not permitted the payment delegation, and the payment delegation reception process ends.

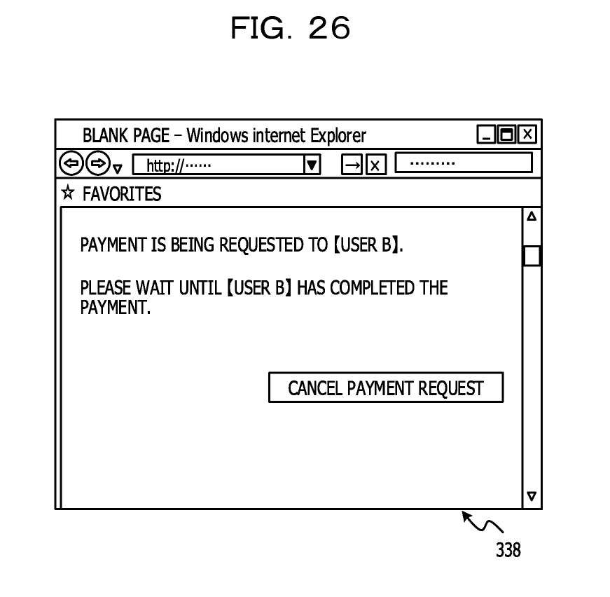

In the case where “OK” is set as the “permission flag” of the delegation permission information read in step 165, the user as the request recipient of the payment delegation has permitted the payment delegation. Therefore, it is determined that the read delegation permission information is valid and an affirmative result is obtained in the determination in step 166. In such a case, as illustrated in FIG. 26, a payment requesting screen 338 for notifying that a payment request is under way is displayed on the display unit 102 of the terminal device 42 operated by the user A, and the process proceeds to step 168.

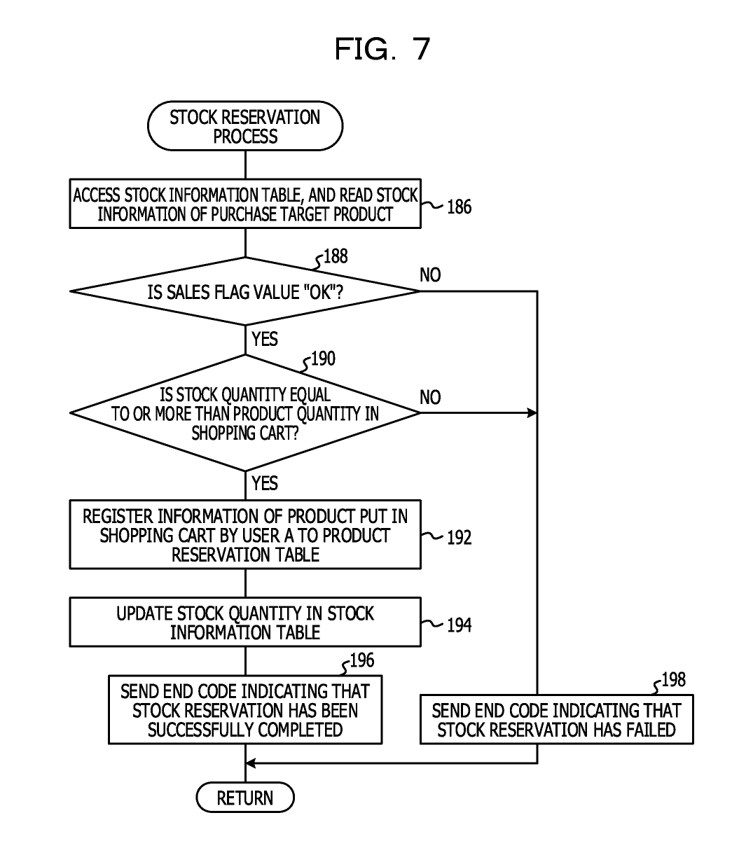

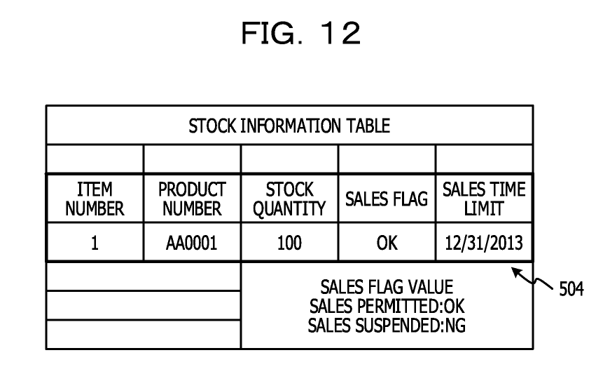

In step 168, the stock information management unit 18 performs a stock reservation process. The stock reservation process will be described below with reference to FIG. 7. In step 186 of the stock reservation process, the stock information management unit 18 searches for and reads stock information corresponding to a purchase target product in the shopping cart of the user A, from among stock information registered in a stock information table 504 illustrated in FIG. 12. The stock information table 504 is provided with fields: “item number”, “product number”, “stock quantity”, “sales flag”, and “sales time limit,” and relevant information is set for each record. As the “sales flag”, “OK” is set for a product for which sales is permitted, and “NG” is set for a product for which sales is suspended due to a stock shortage or for which the date set as a “sales time limit” has expired. The search for stock information in step 186 can be implemented by using a “product number” as a key.

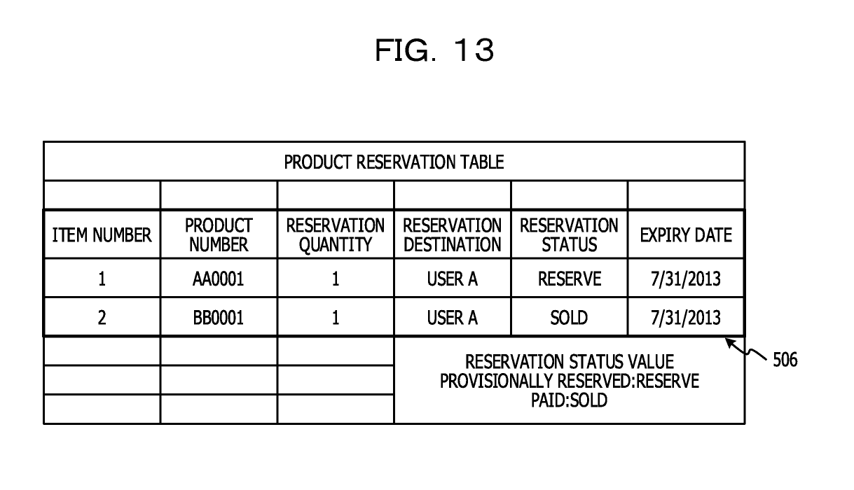

In next step 188, the stock information management unit 18 determines whether or not “OK” is set as the “sales flag” of the stock information read in step 186. When an affirmative result is obtained in the determination in step 188, the process proceeds to step 190. In step 190, the stock information management unit 18 determines whether or not the “stock quantity” of the stock information read in step 186 is equal to or more than the quantity of the product in the shopping cart of the user A. When an affirmative result is obtained in the determination in step 190, the process proceeds to step 192. In step 192, the stock information management unit 18 registers information of the product in the shopping cart of the user A to a product reservation table 506, as illustrated in FIG. 13. Thus, the product is provisionally reserved.

The product reservation table 506 is provided with fields: “item number”, “product number”, “reservation quantity”, “reservation destination”, “reservation status”, and “expiry date”. In the product reservation table 506, the quantity of a product in the shopping cart of the user A is set as the “reservation quantity” and information identifying the user A is set as the “reservation destination”. “RESERVE” is set as the “reservation status” when the product is provisionally reserved, while “SOLD” is set as the “reservation status” when the price of the product has already been paid. In step 192, “RESERVE” is set as the “reservation status”. As the “expiry date”, the expiry date (the date after a certain number of days from the current date) for provisional reservation for the product is set.

In next step 194, the stock information management unit 18 subtracts the “reservation quantity” of the provisionally reserved product from the “stock quantity” of stock information of the provisionally reserved product which is registered in the stock information table 504. Accordingly, the stock information of the provisionally reserved product is updated. Then, in step 196, the stock information management unit 18 sends an end code notifying that stock reservation has been successfully completed, and the stock reservation process ends.

On the other hand, when a negative result is obtained in the determination in step 188 or step 190, the process proceeds to step 198. In step 198, the stock information management unit 18 sends an end code notifying that stock reservation has failed, and the stock reservation process ends.

After the above-mentioned stock reservation process ends, the process proceeds to step 170 of the payment delegation reception process. In step 170, the shopping cart management unit 16 determines, based on the end code sent through the stock reservation process, whether or not stock reservation has been successfully completed. When the end code sent through the stock reservation process is an end code notifying that stock reservation has been successfully completed, an affirmative result is obtained in the determination in step 170, and the process proceeds to step 172.

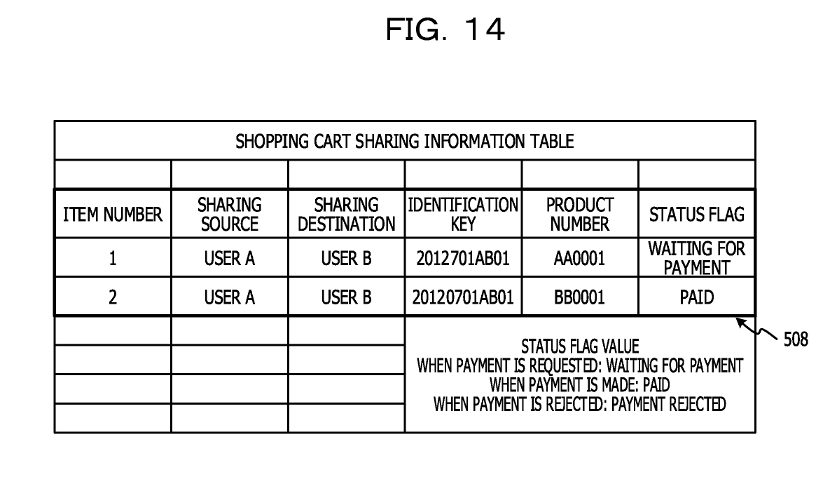

In step 172, the shopping cart management unit 16 issues an identification key for identifying individual payments. The shopping cart management unit 16 records, in a shopping cart sharing information table 508 illustrated in FIG. 14, sharing information of the shopping cart for each product in the shopping cart. The shopping cart sharing information table 508 is provided with fields: “item number”, “sharing source”, “sharing destination”, “identification key”, “product number”, and “status flag”. In the shopping cart sharing information table 508, as the “status flag”, “waiting for payment” is set when payment is requested, “paid” is set when a payment has already been made, and “payment rejected” is set when payment has been rejected.

In step 172, in the shopping cart sharing information table 508, information identifying the user A is set as the “sharing source” and information identifying the user B is set as the “sharing destination”. Further, the issued identification key is set as the “identification key”, and the product number of the product as a payment target is set as the “product number”. In the shopping cart sharing information table 508, “waiting for payment” is set as the “status flag”.

In step 174, the shopping cart management unit 16 sets a flag which indicates that the contents of the shopping cart sharing information table 508 is locked. With the setting of the flag, the user B is prohibited from changing the contents of the shopping cart sharing information table 508.

In step 176, the shopping cart management unit 16 sets, for the shopping cart of the user A (shopping cart sharing information table 508), information which indicates that the shopping cart is shared between the user A and the user B.

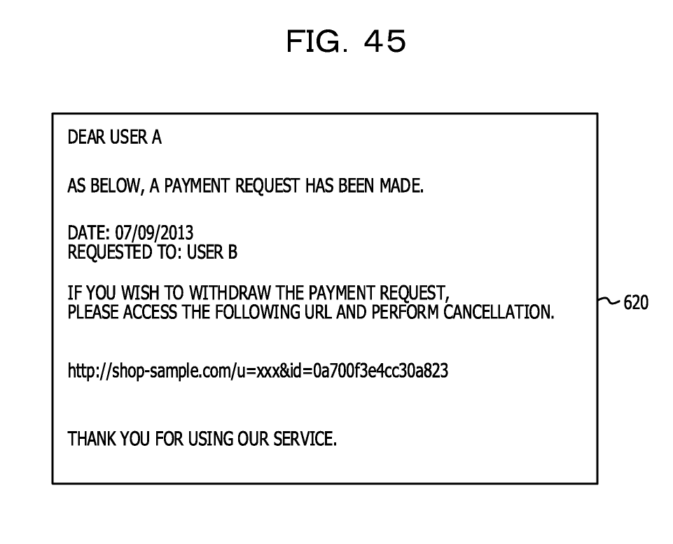

In step 178, the shopping cart management unit 16 sends to the user A and the user B emails notifying that payment request has been made. That is, for example, as illustrated in FIG. 45, the shopping cart management unit 16 sends to the user A a payment request notification email 620 stating that a payment request has been made to the user B. The user A performs an email receiving operation to read the contents of the payment request notification email 620. Accordingly, the user A is notified that the payment request has been made to the user B.

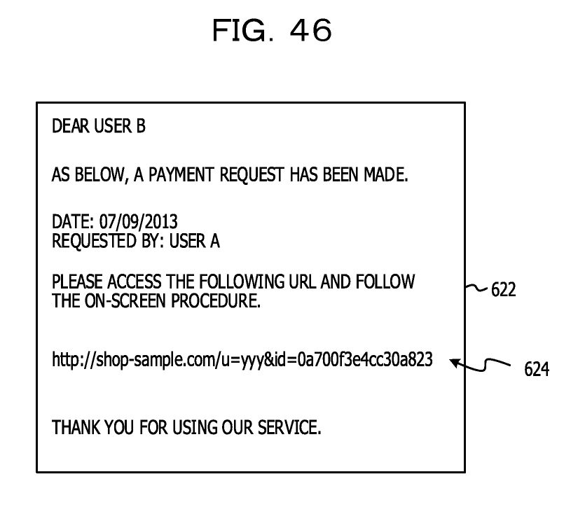

The shopping cart management unit 16 sends to the user B a payment request notification email 622 stating that payment is requested, for example, as illustrated in FIG. 46. The user B performs an email receiving operation to read the contents of the payment request notification email 622. Accordingly, the user B is notified that the payment is requested. To the payment request notification email 622, a link 624 for jumping to a screen on which a payment is made according to the request, is attached. The user B selects the link 624 provided to the payment request notification email 622 and thus jumps to the screen for making a payment.

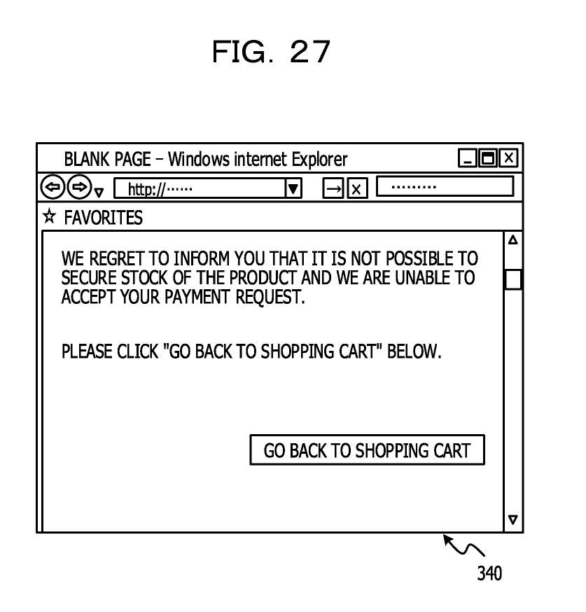

On the other hand, in the case where the end code sent through the stock reservation process is an end code notifying that stock reservation has failed, a negative result is obtained in the determination in step 170, and the process proceeds to step 180. In step 180, the shopping cart management unit 16 does not reserve the stock of a product, as illustrated in FIG. 27. Therefore, the shopping cart management unit 16 displays, on the display unit 102 of the terminal device 42 operated by the user A, a stock reservation failure screen 340 notifying that the payment request is not accepted. Thus, the user A is able to understand that the stock of the product has not been reserved.

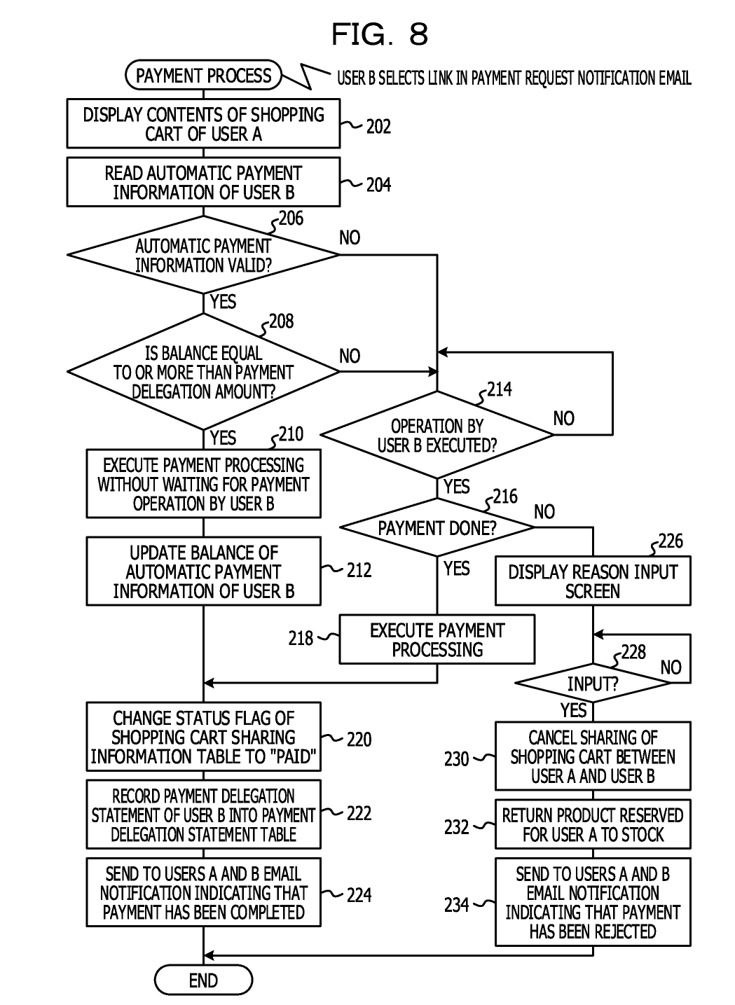

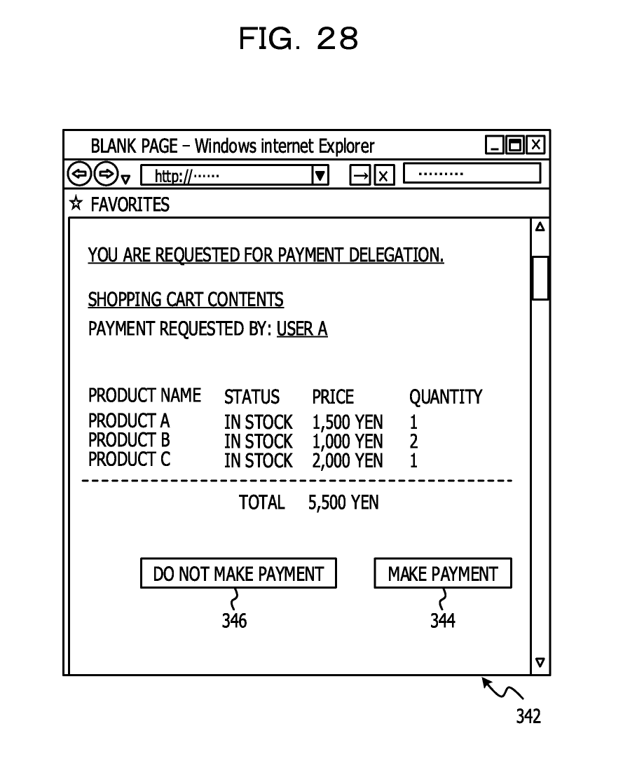

Next, a payment process which is started on the e-commerce server 38 when the user B selects the link 624 provided to the payment request notification email 622, will be described with reference to FIG. 8. In step 202, for example, as illustrated in FIG. 28, the shopping cart management unit 16 generates a shopping cart display screen 342 which displays the contents of the shopping cart of the user A. Then, the shopping cart management unit 16 displays the generated shopping cart display screen 342 on the display unit 102 of the terminal device 42 operated by the user B. On the shopping cart display screen 342, the product name, status (presence of absence of stock), price, and quantity of all the products in the shopping cart are displayed. On the shopping cart display screen 342, a message notifying that there is a payment request is displayed. The shopping cart display screen 342 is provided with buttons 344 and 346 for selecting whether or not to make a payment.

In next step 204, the settlement processing unit 22 attempts reading of automatic payment information of the user B registered in the automatic payment information table 502. In next step 206, the settlement processing unit 22 determines whether or not valid automatic payment information of the user B exists. When valid automatic payment information of the user B has been successfully read, an affirmative result is obtained in the determination in step 206, and the process proceeds to step 208. In step 208, the settlement processing unit 22 determines whether or not the amount set as the “balance” of the read automatic payment information is equal to or more than the payment delegation amount requested by the user A.

When an affirmative result is obtained in the determination in step 208, the process proceeds to step 210. In step 210 and later steps, automatic payment processing is performed. In step 210, the settlement processing unit 22 executes payment processing without waiting for a payment operation by the user B. That is, the “reservation status” of the corresponding record in the product reservation table 506 is changed from “RESERVE” into “SOLD”. In step 212, the user management unit 14 subtracts the price of the product from the “balance” of the automatic payment information of the user B registered in the automatic payment information table 502.

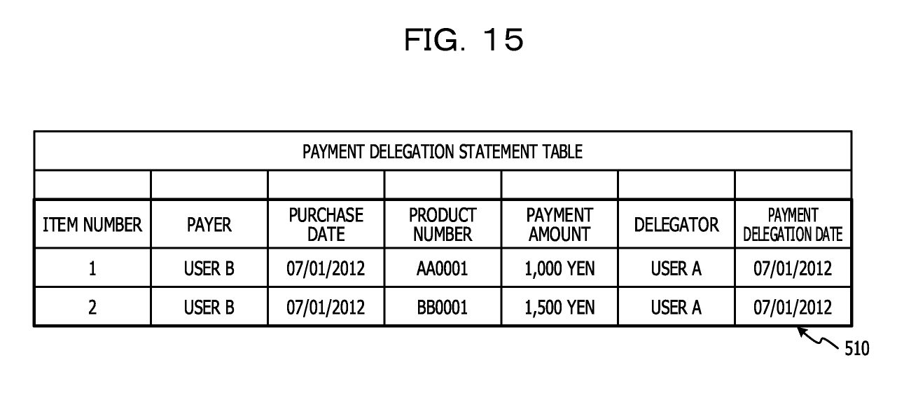

After executing the processing of step 212, the process proceeds to step 220. In step 220, the shopping cart management unit 16 changes the “status flag” of the shopping cart sharing information table 508 from “waiting for payment” into “paid”. In next step 222, the settlement processing unit 22 records payment delegation statement information of the user B in a payment delegation statement table 510 stored in the statement information storage unit 32. As illustrated in FIG. 15, the payment delegation statement table 510 is provided with fields: “item number”, “payer”, “purchase date”, “product number”, “payment amount”, “delegator”, and “payment delegation date”. Information identifying the user B is set as the “payer”, information identifying the user A is set as the “delegator”, and the price of the product is set as the “payment amount”.

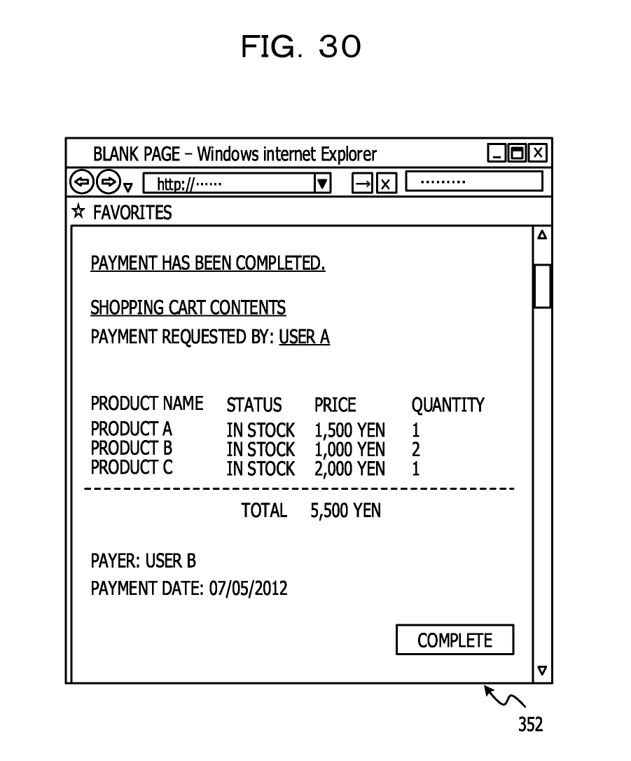

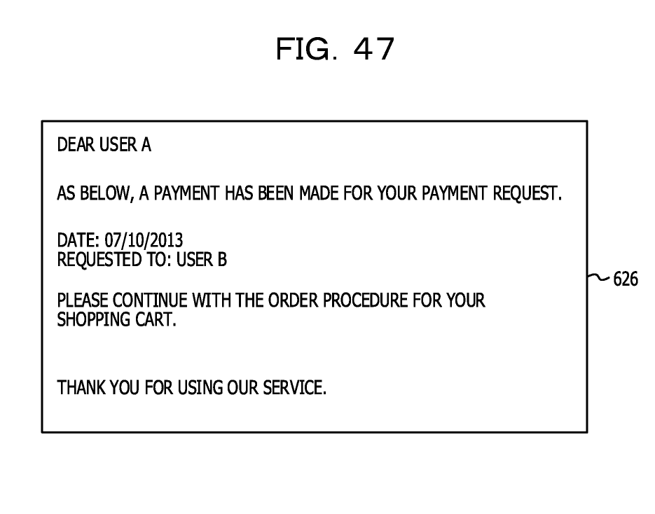

In step 224, the settlement processing unit 22 sends to the user A and the user B emails notifying that a payment has been made. That is, the settlement processing unit 22 sends to the user A a payment completion notification email 626, for example, as illustrated in FIG. 47. The user A performs an email receiving operation to read the contents of the payment completion notification email 626. Accordingly, the user A is notified that a payment has been made by the user B. The settlement processing unit 22 displays a payment completion screen 352 illustrated in FIG. 30 on the display unit 102 of the terminal device 42 operated by the user B.

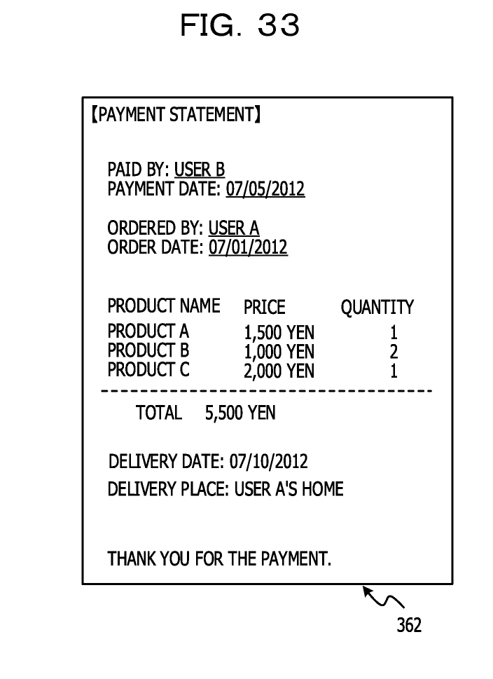

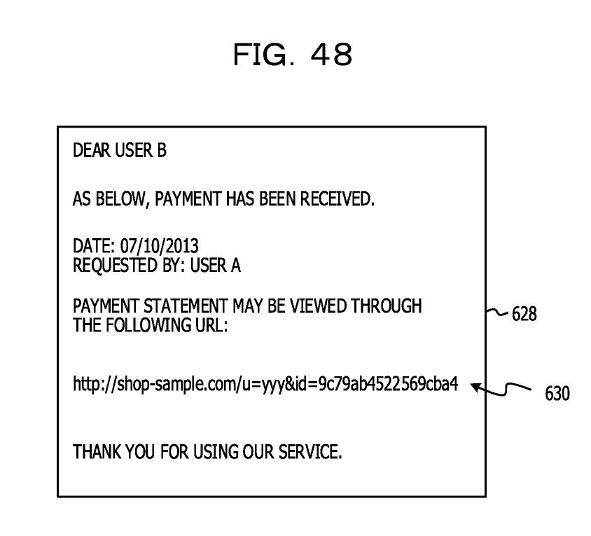

The settlement processing unit 22 sends to the user B a payment completion notification email 628, for example, as illustrated in FIG. 48. The user B performs an email receiving operation to read the contents of the payment completion notification email 628. Accordingly, the user B is notified that the payment has been completed. To the payment completion notification email 628, a link 630 for jumping to a screen for viewing a payment statement is attached. The user B selects the link 630 provided to the payment completion notification email 628 and thus jumps to a payment statement display screen 362 illustrated in FIG. 33.

When valid automatic payment information of the user B does not exist or the “balance” of valid automatic payment information of the user B is less than the amount of payment delegation, a negative result is obtained in the determination in step 206 or 208, and the process proceeds to step 214. In step 214, the settlement processing unit 22 determines whether or not an operation has been performed by the user B. The settlement processing unit 22 repeats step 214 until an affirmative result is obtained in step 214.

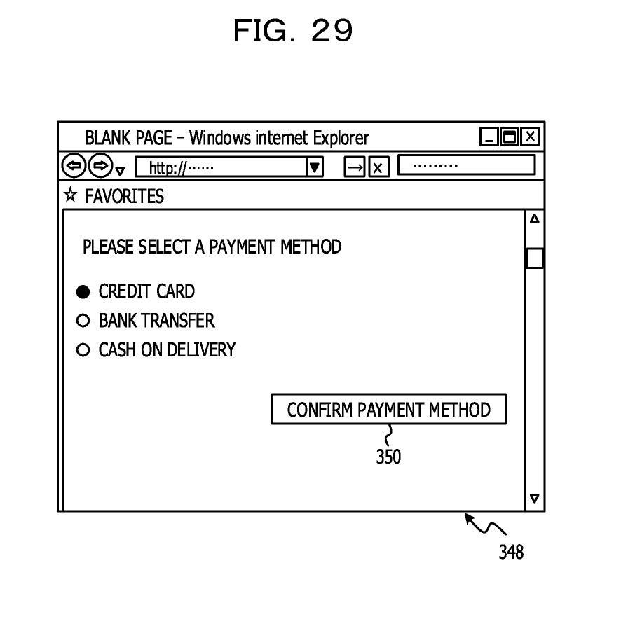

When automatic payment processing based on automatic payment information is not performed, the user B performs an operation for selecting the button 344 or the button 346 in a state where the shopping cart display screen 342 illustrated in FIG. 28 is displayed. When the button 344 is selected, the e-commerce server 38 displays, on the display unit 102 of the terminal device 42 operated by the user B, a payment method selection screen 348 (FIG. 29) on which different types of payment methods are displayed as options and a button 350 for confirming a payment method is provided. The user B performs an operation for selecting a payment method through the payment method selection screen 348.

When the user B performed the above-mentioned operation, an affirmative result is obtained in step 214, and the process proceeds to step 216. In step 216, the settlement processing unit 22 determines whether or not the user B has issued an instruction to make a payment and has selected a payment method. When the user B performs an operation for selecting the button 344 on the shopping cart display screen 342 and then performs an operation for selecting a payment method on the payment method selection screen 348, an affirmative result is obtained in step 216, and the process proceeds to step 218.

In step 218, the settlement processing unit 22 executes payment processing. That is, the settlement processing unit 22 changes the “reservation status” of the corresponding record in the product reservation table 506 from “RESERVE” into “SOLD”. Then, the settlement processing unit 22 performs processing for paying the price of the product in the payment method selected by the user B. After performing the processing of step 218, the process proceeds to step 220. Then, the processing of steps 220 to 224 described above is performed.

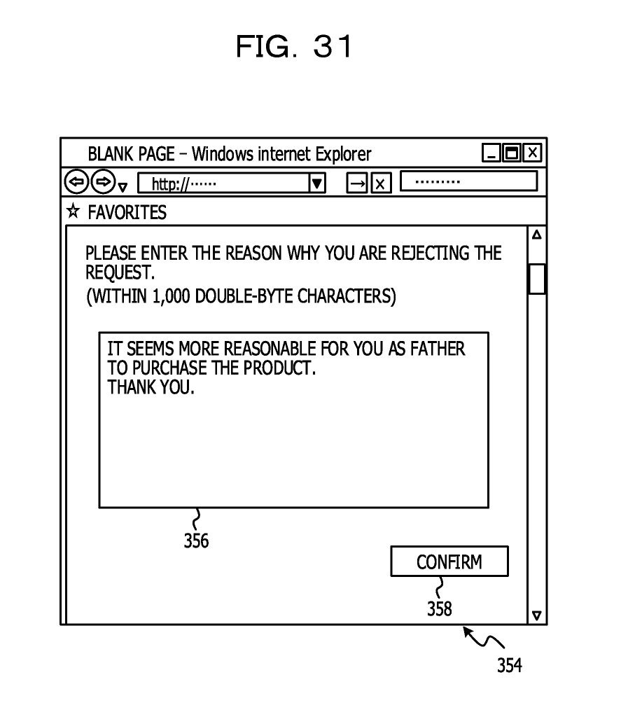

On the other hand, when the user B performs an operation for selecting the button 346 on the shopping cart display screen 342, a negative result is obtained in step S216, and the process proceeds to step 226. In step 226, the reason notification unit 20 displays, on the display unit 102 of the terminal device 42 operated by the user B, a reason input screen 354 (see FIG. 31) which includes an input field 356 for inputting a reason for selection of the button 346 to reject payment.

In next step 228, the settlement processing unit 22 determines whether or not a reason for rejection of the payment has been input to the input field 356 of the reason input screen 354. The settlement processing unit 22 repeats step 228 until an affirmative result is obtained in step 228. When the user B rejects payment, the settlement processing unit 22 inputs a reason for the rejection of the payment through operation on the input unit 100. After input is done, an affirmative result is obtained in step 228 by selection of a button 358 on the reason input screen 354, and the process proceeds to step 230. In step 230, the shopping cart management unit 16 performs processing for canceling the sharing of the shopping cart between the user A and the user B by deleting corresponding information registered in the shopping cart sharing information table 508.

In step 232, the stock information management unit 18 deletes from the product reservation table 506 information of the product that has been provisionally reserved for the user A by registration to the product reservation table 506. The stock information management unit 18 performs processing for returning the provisionally reserved product to the stock by increasing the “stock quantity” of the stock information of the provisionally reserved product registered in the stock information table 504 by the “reservation quantity” of the provisionally reserved product.

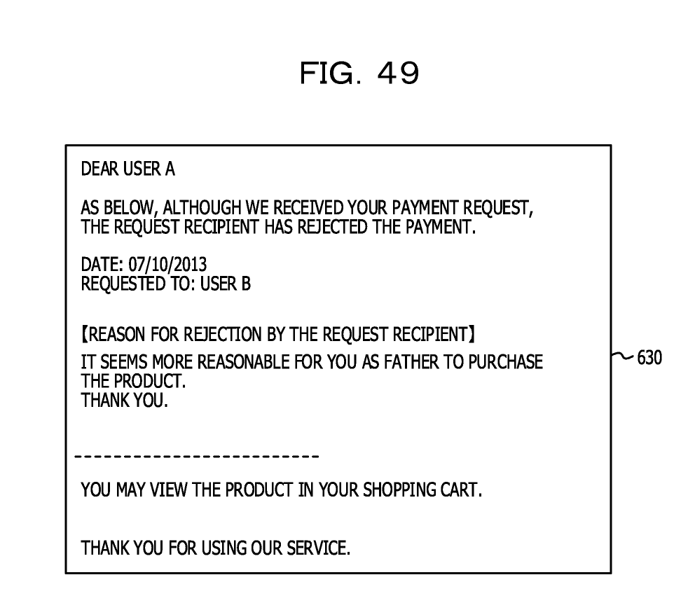

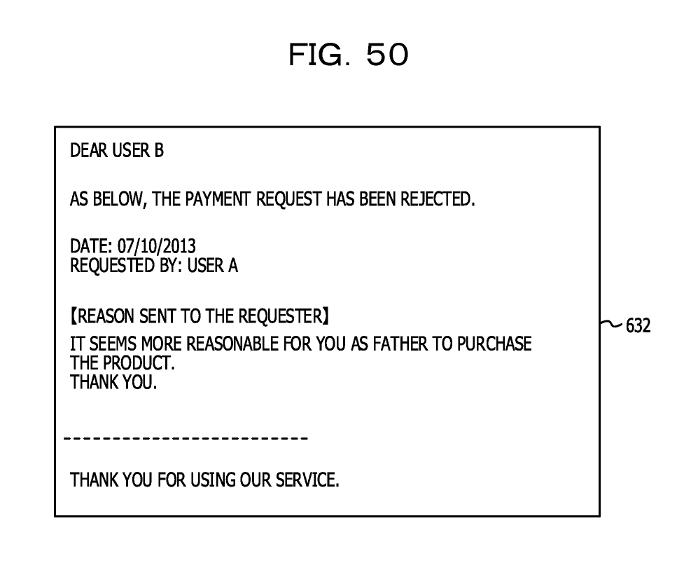

In step 234, the reason notification unit 20 sends to the user A and the user B emails notifying of rejection of the payment by the user B and the input reason for the rejection. That is, the reason notification unit 20 sends to the user A a payment rejection notification email 630, for example, as illustrated in FIG. 49. The user A performs an email receiving operation to read the contents of the payment rejection notification email 630. Accordingly, the user A is notified of rejection of the payment by the user B and the reason for the rejection of the payment. The reason notification unit 20 sends to the user B a payment rejection notification email 632, for example, as illustrated in FIG. 50. The user B performs an email receiving operation to read the contents of the payment rejection notification email 632. Accordingly, the user B is notified that the payment has been rejected.

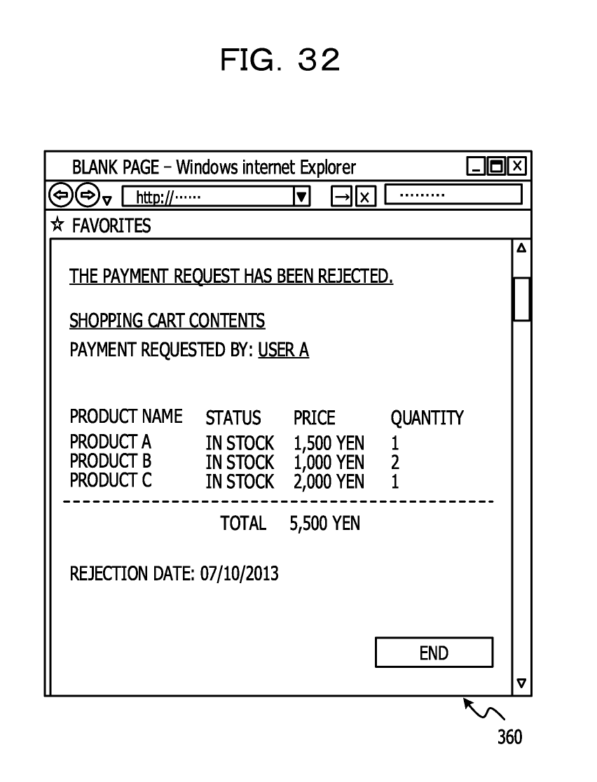

As illustrated in FIG. 32, a payment rejection notification screen 360 notifying that the payment has been rejected is displayed on the display unit 102 of the terminal device 42 operated by the user B. By browsing the payment rejection notification screen 360, the user B is able to confirm that he/she has rejected the payment.

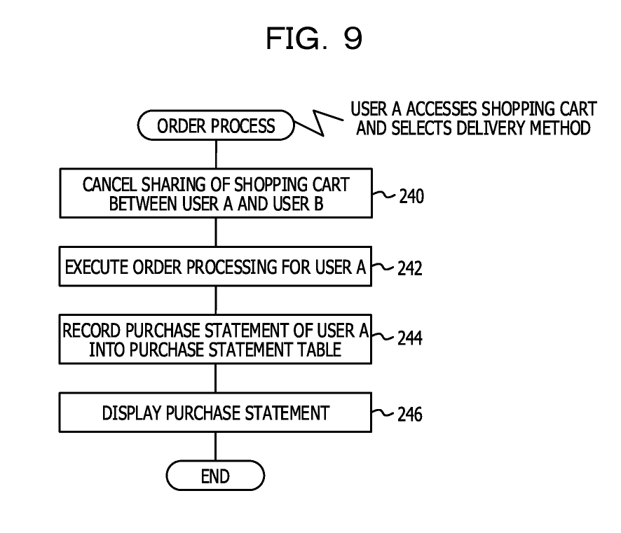

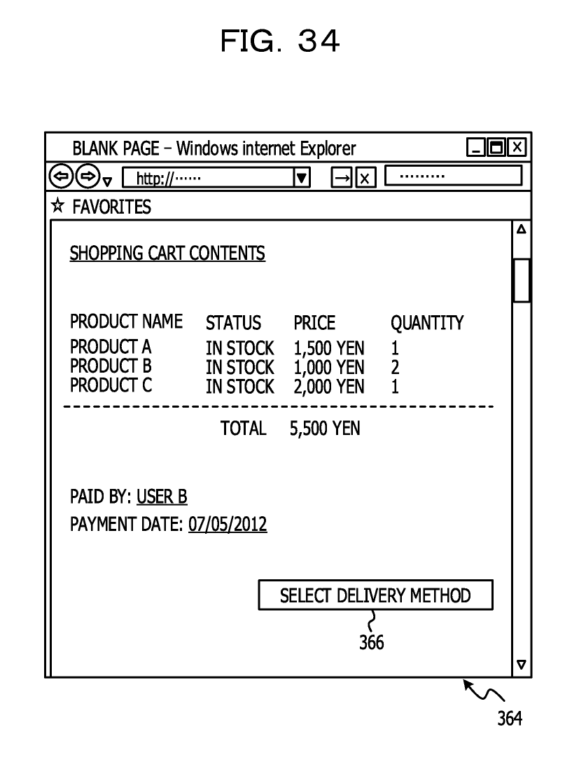

On the other hand, when receiving the payment completion notification email 626, the user starts a browser on the terminal device 42. Then, the user A accesses a product sales website while performing an operation for specifying the URL and the like, and then follows links. Accordingly, the user A performs an operation for accessing the shopping cart of the user A. Thus, a shopping cart display screen 364 illustrated in FIG. 34 is displayed on the display unit 102 of the terminal device 42 operated by the user A. A button 366 for selecting a delivery method is provided on the shopping cart display screen 364. When the user A selects the button 366, a delivery method selection screen is displayed on which different types of delivery methods are provided as options. When the user A selects a delivery method on the delivery method selection screen, an order process illustrated in FIG. 9 is executed by the e-commerce server 38.

In step 240 of the order process, the shopping cart management unit 16 performs processing for canceling sharing of the shopping cart between the user A and the user B by deleting corresponding information registered in the shopping cart sharing information table 508. In next step 242, the settlement processing unit 22 performs order processing for sending the product ordered by the user A using the delivery method selected by the user A.

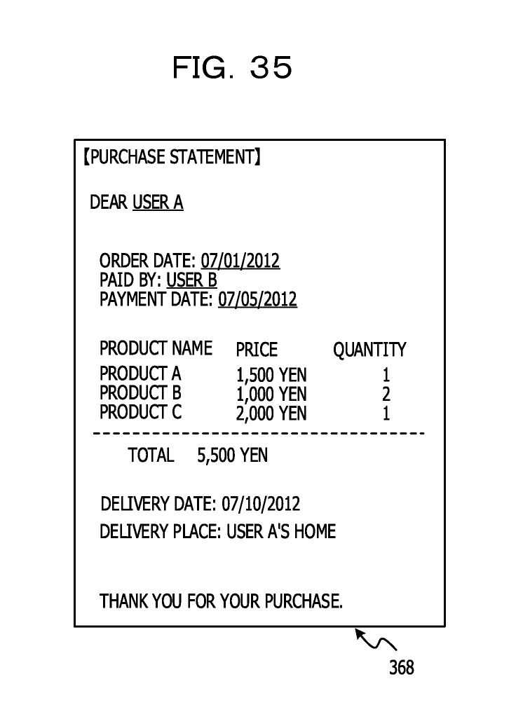

In step 244, the settlement processing unit 22 records purchase statement information of the user A in a purchase statement table 512. The purchase statement table 512 is provided with fields: “item number”, “purchaser”, “purchase date”, “product number”, “purchase price”, “payer”, and “payment date”, and relevant information is set for each field. In step 246, the settlement processing unit 22 displays a purchase statement screen 368 illustrated in FIG. 35 is displayed on the display unit 102 of the terminal device 42 operated by the user A. Accordingly, the user A is able to view the purchase statement.

As described above, in the embodiment, the user A queries the user B as to permission for payment delegation in which payment of the price of a product that the user A wants to purchase is delegated to the user B. When the payment delegation is permitted by the user B, delegation permission information is stored into the delegation permission information table 500. In the case where the user A requests the user B to pay for the product that the user A wants to purchase and corresponding delegation permission information is stored in the delegation permission information table 500, a shopping cart lint describing the name, quantity, and price of the purchase target product is presented to the user B. Then, the user B is requested to make a payment. In the case where the user B issues an instruction to pay the price of the product whose name, quantity, and price are described in the shopping cart list, the settlement processing unit 22 performs settlement processing for settling the price of the product based on funds of the user B.

Accordingly, procedures for payment delegation are taken in advance and payment is then requested. Therefore, a user with malicious intent is not allowed to request any other user to make a payment, and the security of e-commerce transactions is ensured. It is also possible to request users in relationships other than a family relationship to make a payment. Furthermore, since what a payer is to do is only an operation for paying the price of a product put in a shopping cart list, an e-commerce transaction with a lower load of the payer may be attained, compared to the case where a payer performs an operation for inputting a product into a shopping cart.

In the embodiment, in the case where an instruction for setting automatic payment is issued and the credit limit for automatic payment in the case of payment delegation is input by the user B, the settlement processing unit 22 stores automatic payment information including the input credit limit into the automatic payment information table 502. In the case where the user A requests the user B to pay for a product that the user A wants to purchase, delegation permission information is stored in the delegation permission information table 500, and the price of the product is less than or equal to the credit limit included in automatic payment information stored in the automatic payment information table 502, the settlement processing unit 22 performs the processing described below. That is, the settlement processing unit 22 performs settlement processing for settling the price of the product based on funds of the user B, without waiting for an instruction from the user B, and updating the credit limit included in the automatic payment information. Accordingly, payment for a product whose price is less than or equal to the credit limit may be performed without causing the user B who makes a payment to perform complicated operations.

In the embodiment, in the case where the user A requests the user B to pay for a product that the user A wants to purchase, the stock information management unit 18 subtracts the quantity of the product described in a shopping cart list from the stock quantity in the stock information table 504. The stock information management unit 18 performs processing for provisionally reserving the product by registering the product corresponding to the quantity described in the shopping cart list to the product reservation table 506 in a provisionally reserved state. Accordingly, a state in which a stock shortage occurs when the user B pays the price of the product does not occur.

In the embodiment, in displaying a shopping cart list on the display unit 102 of the terminal device 42 operated by the user B, the shopping cart management unit 16 locks the shopping cart list so that the user B is prohibited from changing the shopping cart list. Accordingly, the shopping cart list is not carelessly changed by the user B.

In the embodiment, when the user B rejects the payment of the price of a product described in a shopping cart list, the settlement processing unit 22 displays the reason input screen 354 for inputting the reason for rejection of the payment on the display unit 102. Then, the reason notification unit 20 notifies the user A of the reason for the rejection of the payment input through the reason input screen 354. Accordingly, when the user B rejects payment, the user A is able to understand the reason for the rejection of the payment.

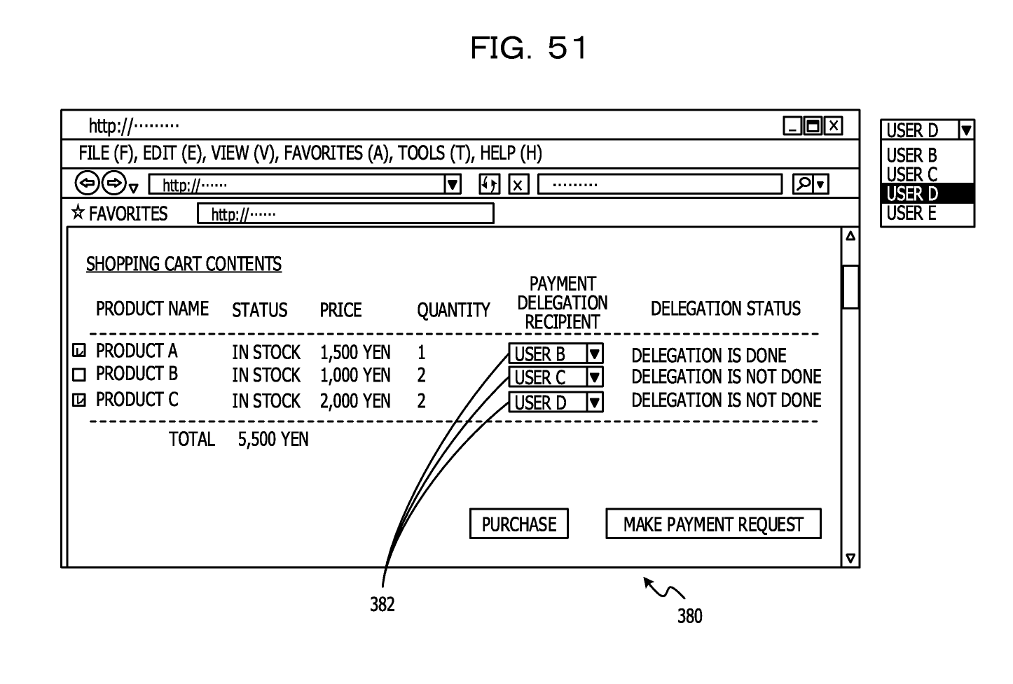

Although the case where only the user B is requested for payment delegation from the user A in units of shopping carts has been described above, a plurality of users may be requested for payment delegation from the same user for individual products in a shopping cart. In this case, for making a request for payment, instead of the shopping cart display screen 330 illustrated in FIG. 24, a shopping cart display screen 380 illustrated in FIG. 51 may be displayed. On the shopping cart display screen 380, payment delegation recipients may be selected in units of products put in the shopping cart. In a payment delegation recipient selection screen 382, users to whom payment is delegated are listed in a pull-down menu as options. By selecting a desired user from the users listed as options, different payment delegation recipients may be set for individual products.

Although the case where deposit settlement processing is actually performed at the registration of automatic payment information has been described above, only the credit limit may be registered at the registration of automatic payment information and deposit settlement processing may be performed when settlement of the price of a product is requested by the user A.

Although the case where a product is purchased has been explained above as an example, the embodiment may also be applied to the case where a payment is made for provision of a service.

Although an aspect in which the purchasing service providing program 64 as an example of a purchasing service providing program according to a disclosed technique is stored (installed) in advance in the storage unit 48 has been explained above, the embodiments are not limited to this. A purchasing service providing program according to a disclosed technique may be recorded in a recording medium, such as a compact disc-read only memory (CD-ROM) or a digital versatile disc-read only memory (DVD-ROM), and distributed.

All cited documents, patent applications, and technical standards mentioned in the present specification are incorporated by reference in the present specification to the same extent as if the individual cited documents, patent applications, and technical standards were specifically and individually incorporated by reference in the present specification.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A purchasing service providing method executed by a processor included in a purchasing service providing apparatus, the method comprising:
transmitting, to a second computer, a request for payment delegation in which payment of a price of a product or a service to be purchased through a first computer is delegated to the second computer;
receiving a payment request for the payment of the price from the first computer, the payment request including information of a name and the price of the product or the service;
transmitting the payment request to the second computer, and performing processing for the payment using funds corresponding to the second computer when an instruction for conducting the processing for the payment is received from the second computer, when a permission notification indicating that the payment delegation is permitted is received from the second computer and the price is more than a credit limit of the payment; and
conducting the processing for the payment using the funds and updating the credit limit based on the price, when the permission notification is received from the second computer and the price is less than or equal to the credit limit.

2. The purchasing service providing method according to claim 1, further comprising:
transmitting to the second computer the payment request as well as the information of the name and the price of the product or the service, when the permission notification is received from the second computer and the credit limit is not stored in a memory; and
conducting the processing for the payment using the funds when the instruction for conducting the processing for the payment is received from the second computer.

3. The purchasing service providing method according to claim 1, wherein the receiving the payment request for the payment of the price includes receiving from the first computer the payment request for the payment of the price, the payment request including information of the name, a quantity, and the price of the product or the service.

4. The purchasing service providing method according to claim 3, further comprising:
storing information of a stock quantity of the product into the memory; and
updating the stock quantity by subtracting the quantity of the product from the stock quantity before conducting the processing for the payment when the payment request for the payment of the price is received from the first computer.

5. The purchasing service providing method according to claim 1, wherein the transmitting to the second computer the payment request includes displaying the information of the name and the price of the product or the service on a display device of the second computer.

6. The purchasing service providing method according to claim 5, wherein the displaying includes setting the information of the name and the price of the product or the service displayed on the display device so as not to be changed through the second computer.

7. The purchasing service providing method according to claim 5, further comprising:
causing the display device to display a reason input screen for inputting a reason for rejection of the payment on the display device and transmitting information of the reason input through the reason input screen to the first computer, when a notification indicating that the payment is rejected is received from the second computer.

8. A non-transitory computer-readable storage medium storing a program causing a computer to execute a process, the process comprising:
transmitting, to a second computer, a request for payment delegation in which payment of a price of a product or a service to be purchased through a first computer is delegated to the second computer;
receiving a payment request for the payment of the price from the first computer, the payment request including information of a name and the price of the product or the service;
transmitting the payment request to the second computer, and conducting processing for the payment using funds corresponding to the second computer when an instruction for conducting the processing for the payment is received from the second computer, when a permission notification indicating that the payment delegation is permitted is received from the second computer and the price is more than a credit limit of the payment; and
conducting the processing for the payment using the funds and updating the credit limit based on the price, when the permission notification is received from the second computer and the price is less than or equal to the credit limit.

9. A purchasing service providing apparatus, comprising:
a memory; and
a processor coupled to the memory and configured to:
transmit, to a second computer, a request for payment delegation in which payment of a price of a product or a service to be purchased through a first computer is delegated to the second computer;
receive a payment request for the payment of the price from the first computer, the payment request including information of a name and the price of the product or the service;
transmit the payment request to the second computer when the delegation permission information is stored in the memory and the price is more than the credit limit, and conduct processing for the payment using funds corresponding to the second computer when an instruction for conducting the processing for the payment is received from the second computer, when a permission notification indicating that the payment delegation is permitted is received from the second computer and the price is more than a credit limit of the payment; and
conduct the processing for the payment using the funds and update the credit limit based on the price, when the permission notification is received from the second computer and the price is less than or equal to the credit limit.

10. The purchasing service providing apparatus according to claim 9, wherein the processor is further configured to:
transmit to the second computer the payment request as well as the information of the name and the price of the product or the service, when the permission notification is received from the second computer and the credit limit is not stored in a memory; and
conduct the processing for the payment using the funds when the instruction for conducting the processing for the payment is received from the second computer.

11. The purchasing service providing apparatus according to claim 9, wherein the processor is configured to receive from the first computer the payment request for the payment of the price, the payment request including information of the name, a quantity, and the price of the product or the service.

12. The purchasing service providing apparatus according to claim 11, wherein the processor is further configured to:
store information of a stock quantity of the product into the memory; and
update the stock quantity by subtracting the quantity of the product from the stock quantity before conducting the processing for the payment when the payment request for the payment of the price is received from the first computer.

13. The purchasing service providing apparatus according to claim 11, wherein the processor is configured to display the information of the name and the price of the product or the service on a display device of the second computer.

14. The purchasing service providing apparatus according to claim 13, wherein the processor is configured to set the information of the name and the price of the product or the service displayed on the display device so as not to be changed through the second computer.

15. The purchasing service providing apparatus according to claim 13, wherein the processor is configured to cause the display device to display a reason input screen for inputting a reason for rejection of the payment on the display device and transmitting information of the reason input through the reason input screen to the first computer, when a notification indicating that the payment is rejected is received from the second computer.
